(19) United States
(12) Patent Application Publication
(10) Pub. No.: US 2004/0028357 A1
(43) Pub. Date: Feb. 12, 2004

(54) Optical matrix photonic logic device and method for producing the same

(76) Inventor: Michael J. Pender, Arlington, VA (US)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/470,387

(22) PCT Filed: May 21, 2001
(86) PCT No.: PCT/IB01/00888

(51) Int. Cl. G02B 6/00

(52) U.S. Cl. 385/122

(57) ABSTRACT

A photonic logic device, such as an optical matrix (105), may include input ports for receiving photonic signals and output ports for transmitting result signals. A plurality of optical elements (130-183) may be configured to implement Boolean functions (210) of information encoded within the received signals to produce the result signals. A photonic logic device may be configured to implement any Boolean function (350) by combining photonic XOR and OR devices (360), or with an automated design process (510-570) based on an evolutionary programming technique (610-680). The photonic logic device may then be manufactured using masking techniques.

### BACKGROUND OF THE INVENTION

### FIELD OF THE INVENTION

The invention relates generally to photonic logic devices including smart photonic switch devices used in optical switching and communications.

### DESCRIPTION OF THE RELATED ART

Photonic logic devices are a first step in the miniaturization of photonic devices and a critical missing link in building an all-optical Internet. The transmission of high frequency signals by electrical cabling incurs a significant power loss compared to using fiber optic cabling. Transmitting a 100 MHz signal across a 1.0 km distance using a typical electrical cable incurs a signal power loss nearly a thousand times larger than transmitting the same signal over a single mode fiber optic cable at optical carrier wavelengths. Consequently, fiber optic signal cables are preferred when transmitting signals over long distances. A significant difficulty with constructing wide-area networks using fiber optic cables is that routing optical information requires converting photonic signals into electrical signals for analysis by electronic switches, followed by conversion back into photonic signals for retransmission.

One of the first critical applications for photonic switches will be to eliminate electronic switching in fiber-optic Internet backbones. As photonic signals become increasingly complex, the bandwidth of electronic switches may become insufficient. In response to this need, several companies have developed prototype electro-optical switches to better meet the demand for bandwidth. However, even though electro-optical switches can redirect photonic signals, the switches are unable to interpret the data encoded within the photonic signals. Thus, electronic switches are still needed to interpret the data packets contained within the photonic signals to route the packets. Therefore, there is a need for a photonic logic device with the speed of optics and the intelligence of microelectronics to interpret photonic signals. Various approaches have been suggested for integrating microelectronics and photonic circuitry within a chip, such as by creating photonic wiring between transistors. However, the continued use of electronics would impose several significant limitations.

First, the operating speed of an electronic computer is limited by delays in redistributing information around the processor chip. A transistor is a trans-resistive device in which a change of state is effected by adjusting a variable resistance, causing a memory capacitor to charge or discharge. The delays are primarily due to resistive and capacitive effects that do not decrease as electronic circuitry is scaled down in size; rather, the delays generally increase, as noted in Richard Turton's The Quantum Dot: A Journey into the Future of Microelectronics, p.174. Unlike electronic signals, photonic signals do not suffer from capacitive or resistive effects.

In contrast, an optical matrix device may change logical state in the time it takes for photons to propagate across the optical matrix. Photons travel at a speed approximately a hundred times faster than electrical signals. Thus, it would be preferable to implement logic devices with optical matrices instead of electronic switches. Furthermore, Einstein's theory of relativity provides that a photonic signal is the fastest way to communicate information from one point to another.

Second, electronic devices are highly susceptible to environmental conditions. Electronic devices may be damaged by over-voltage conditions, brownouts or blackouts, and may latch-up if operated in an under-voltage condition. Electronic devices may be destroyed by electromagnetic pulses or electrostatic discharges if mishandled. Additionally, a lightning strike in the vicinity of a cable connected to an electronic computer network may endanger the entire network. Also, electronic devices are sensitive to interference, such as intermodulation, intersymbol interference and electromagnetic interference generated by radio stations, cellular telephone towers, high-tension power lines, and other electronic devices. Electronic devices are also susceptible to damage by ionizing radiation, such as the radiation produced by solar flares and the North Atlantic Anomaly.

Therefore, electronic devices used for communication networks must be thoroughly shielded against adverse environmental conditions, such as electromagnetic interference and ionizing radiation. In contrast, optical devices are essentially immune to electromagnetic interference and ionizing radiation. Consequently, optical matrix devices are preferred over electronic devices for use in adverse environmental conditions.

Finally, electronic devices generate heat from the friction that results when electrons interact with each other. Electronic devices must be cooled to maintain the devices in working order. There are three primary modes by which thermal energy may be transferred: conduction, convection, and radiation. Thermal design imposes significant constraints on electronic devices intended for use in spacecraft design because only the radiation transfer mode is available. Thus, thermal design is a critical factor for spacecraft applications, significantly affecting the size, weight, power requirements and service lifetime of spacecraft. In contrast, photons do not interact with each other under most circumstances and thus need not produce heat from friction. Consequently, optical matrix devices are preferable for temperature-constrained applications, such as space vehicles and communications satellites.

Many researchers believe that a solution to these deficiencies will result from the use of quantum computers, designed on the basis of quantum principles, as described by John Gribbin in “quantum computer,” Q is for Quantum: An Encyclopedia of Quantum Physics (2000). However, the current model for quantum computer devices relies upon large structures requiring superconducting magnets and liquid helium coolant, as described in M. Mitchell Waldrop's “Quantum Computing,” MIT Technology Review, May/June 2000. Quantum computers based on such a model would be multimillion dollar systems that fill entire rooms, which only governments could afford. Additionally, such quantum computers are based on a qu-bit memory model, that is not backwards-compatible with standard software libraries based on Boolean logic.

Therefore, there is a need for a photonic logic device that may be configured as a smart photonic switch to enable an all-optical Internet. Additionally, photonic logic devices may have speed comparable to quantum computers, while retaining compatibility with software libraries based on traditional Boolean logic, and without requiring support structures such as superconducting magnets or liquid helium coolant. Moreover, photonic logic devices may be manufactured at prices comparable to semiconductor devices. Furthermore, photonic logic devices are desirable for avoiding many of the limitations of electronic computer networks, including signal attenuation and environmental sensitivity. Finally, smart photonic switches eliminate many of the risk factors that degrade reliability of electronic computer networks.

Optical matrix switches may have many advantages over traditional electronic and electro-optical switches. First, optical matrix switches may be significantly faster than transistor-based switches. Second, optical matrices may be constructed using electrically non-conductive materials, such as glass fibers, that are highly resistant to environmental conditions including temperature, humidity and electric shock. Additionally, electrically non-conductive materials do not couple electrical signals from the external environment, such as radio stations, cellular telephone towers, high-tension power lines, and electronic devices. Thus, optical matrices require minimal shielding against environmental conditions. Finally, optical matrices generally do not require temperature regulation. In general, photons do not interact with each other and therefore do not generate the heat that results from friction when electrons interact with each other. Therefore, optical matrices typically do not generate significant heat and do not require supplemental cooling. For at least these reasons, optical matrix devices are a desirable replacement for transistors.

### SUMMARY OF THE INVENTION

To address the above and other limitations of the prior art, methods and systems are provided that may be used to easily and effectively implement a photonic logic device, such as a smart photonic switch. The optical matrix of the present invention may be configured to implement a photonic logic device that overcomes many limitations and deficiencies of the prior art.

Prior-art electro-optic switches are unable to interpret and respond to data encoded within a photonic signal. The photonic signal must first be converted to an electrical signal and interpreted by transistor-based electronic circuits. In the present invention, an optical matrix may be configured as a photonic logic device, such as a smart photonic switch that interprets and responds to data encoded within the photonic signal and routes the photonic signal accordingly. An optical matrix may implement a logic function by configuring optical elements in the matrix to produce an interference pattern corresponding to the logic function. An optical matrix may generate one or more output signals by combining the energy of one or more input signals; consequently, an optical matrix may switch photonic signals without consuming energy in the process. When properly configured, an optical matrix may implement logic functions using photonic signals, such as the Boolean logic functions used in electronic computers.

The present invention is directed, in a first embodiment, to an optical matrix configured as a photonic logic device. The device includes at least one input port, configured to receive at least one photonic signal and at least one output port, configured to transmit a logical result signal. The device also includes a plurality of optical elements that interact with the at least one photonic signal, based on information encoded within the at least one photonic signal, to produce the logical result signal.

With respect to the first embodiment, the optical elements may be a three-dimensional structure having multiple layers of optical material and have at least one dimension less than a wavelength of the at least one photonic signal. Additionally, the optical elements may be configured to implement a Boolean function, wherein the logical result signal is an output of the Boolean function based on information encoded within two or more photonic signals received by the optical matrix. Also, the encoded information may correspond to a phase difference between the two or more photonic signals that determines an interference pattern of the optical matrix, wherein amplitude of the logical result signal is proportional to an amplitude of the interference pattern.

The present invention is also directed, in a second embodiment, to a photonic logic device, which is not necessarily an optical matrix. The photonic logic device includes input means for receiving at least two photonic signals, having information encoded within them, as well as output means for outputting at least one photonic result signal. The photonic logic device also includes interference means for determining an interference pattern corresponding to a Boolean function of the information encoded within the received signals, wherein an amplitude of the at least one result signal is proportional to an amplitude of the interference pattern.

With respect to the second embodiment, the amplitude of the at least one photonic result signal may correspond to a Boolean XOR function of the information encoded within the received signals. Also, the amplitude of the at least one photonic result signal may also correspond to a Boolean OR function of the information encoded within the received signals. In addition, the means for determining an interference pattern may determine an interference pattern corresponding to any Boolean function of the information encoded within the received photonic signals by combining Boolean XOR and OR logic functions. Furthermore, the output means may comprise means for outputting at least two photonic result signals including one or more result signals, each result signal having amplitude proportional to an amplitude of the interference pattern, and a termination signal, having amplitude proportional to a difference between amplitudes of the received signals and the one or more result signals.

The present invention is also directed, in a third embodiment, to a process of routing photonic signals using an optical matrix configured as a photonic switch, and a system for implementing the process. At least one photonic signal is received at an input port and a photonic reference signal is received at an input port. Information, encoded within the at least one photonic signal and the photonic reference signal, is processed using a plurality of optical elements of the optical matrix. An output port of the optical matrix is selected according to the processed information and the received signal is transmitted from the selected output port.

The present invention is also directed, in a fourth embodiment, to a process for determining a response of a physical system to photonic signals through a path-tracing system and computer program product directed to the same. The method involves dividing the physical system into unit segments, with each unit segment having a number of faces. The probabilities that a photon will intersect with each face of the number of faces for each of the unit segments is determined, where the photon enters a first face of the number of faces. A transition matrix for a path of the photon through the unit segments is determined based on the determined probabilities, and a Markov process is determined to represent the physical system. The Markov process is solved using the transition matrix to determine the response of the physical system to photonic signals.

In the latter embodiments, the probabilities that a photon will intersect with each face may be determined partially as a function of a geometry of each unit segment. Also, the probabilities that a photon will intersect with each face may include setting a non-zero value to a probability that the photon will intersect again with the first face, when the physical system has phosphorescent or fluorescent properties. The probabilities that a photon will intersect with each face may also be associated with interactions of photons with electrons to produce optical interference and scattering effects. Additionally, the method may also include dividing the physical system into unit segments having fractal properties.

The present invention is also directed, in a fifth embodiment, to a process for automated design of a device using an evolutionary technique, and a computer program product for implementing the process. The process includes representing the device with a configuration of elements of the device; identifying at least one desired property of the device; generating at least one fitness metric based on the at least one identified property; setting a first population of configurations; determining the fitness of each configuration in the first population of configurations with the at least one fitness metric; ranking the first population of configurations according to determined fitness of each configuration; and determining if a termination criterion of the evolutionary process is satisfied. If the termination criterion is satisfied, the process includes outputting a best-ranked configuration in the first population of configurations. Otherwise, the process includes setting a second population of configurations of elements of the device, using operators selected according to an evolution strategy and the ranked configurations. Then the process repeats with determining the fitness of configurations until a termination criterion is satisfied.

With respect to the fifth embodiment, the operators may include a copy operator for copying at least one configuration from the first population to the second population. The operators may also include a mutate operator for inverting one or more elements in a configuration from the first population and inserting a new configuration having one or more inverted elements in the second population. The operators may further include a meiosis operator for combining elements from at least two configurations from the first population and inserting a new configuration having one or more combined elements into the second population. The operators may also include a random operator for inserting a new configuration having random elements into the second population. The operators may further include an inversion operator for inverting all elements of a configuration from the first population and inserting a new configuration having inverted elements in the second population. In addition, each configuration may be a software object including first information, indicating a specific configuration of each element of the device; second information, indicating whether the fitness of the specific configuration has been determined with the at least one fitness metric; and third information, indicating a result of determining the fitness of the specific configuration with the at least one fitness metric.

With respect to the fifth embodiment, the process may also be used for configuring an optical matrix as a photonic logic device and a computer program product on a computer usable medium having a computer readable program code embodied in the medium for causing a computer to determine a configuration of an optical matrix as a photonic logic device. The present invention is also directed to a system for configuring an optical matrix as a photonic logic device. The process includes inputting parameters of a physical process performed by the optical matrix to implement the photonic logic device. The process also includes representing the physical process with a configuration of optical elements of the optical matrix; identifying a logic function to be implemented; and generating at least one fitness metric based on identified logic function. The evolutionary process may include a genetic search process, using the at least one fitness metric, to determine an optimal configuration of the optical elements to implement the identified logic function, then outputting the optimal configuration of the optical elements to implement the identified logic function. The process may additionally include mapping the optimal configuration onto the optical matrix using masking techniques.

In the latter embodiments, the genetic search process may include setting an initial population of configurations of optical elements of the optical matrix and determining the fitness of each configuration in the population of configurations with the at least one fitness metric. The search process also includes ranking the population of configurations according to determined fitness of each configuration and determining if a termination criterion of the genetic search process is satisfied. A best ranked configuration in the population of configurations is output when the termination criterion is satisfied. Otherwise, a second population of configurations of optical elements of the optical matrix is set using an evolution strategy and the ranked configurations when the termination criterion is not satisfied. Then the process repeats with determining the fitness of configurations until a termination criterion is satisfied.

With respect to the genetic search process, determining the fitness of each configuration includes determining an interference pattern, produced by the optical elements in response to the photonic signals, by raytracing the photons through the optical matrix. The raytracing process includes determining probabilistic paths of the photons through the optical matrix. The probabilistic paths comprise transfer paths through four-dimensional space, and each transfer path has an associated probability that is proportional to the likelihood that the photons will traverse the transfer path. Also, with respect to the genetic search process, setting the second population includes applying operators to the ranked configurations, according to the evolution strategy, to generate the second population of configurations.

The above and other features and advantages of the invention will become apparent from the following description of the preferred embodiment, taken in conjunction with the accompanying drawings.

### BRIEF DESCRIPTION OF THE DRAWINGS

FIG. 1 shows an exemplary optical matrix that may be configured as a photonic logic device, such as a smart photonic switch;

FIG. 2 shows a complete set of Boolean mapping functions that associate two input values to output values;

FIG. 3 shows several sets of Boolean functions with an exemplary implementation of each Boolean function using Boolean primitives;

FIG. 4 shows an exemplary amplitude envelope that may result when adding two phasors that have approximately equal magnitude and a relative phase difference.

FIG. 5 shows an exemplary flowchart for configuring an optical matrix as a photonic logic device, such as a smart photonic switch;

FIG. 6 shows an exemplary flowchart for selecting a configuration of optical elements to implement a desired photonic logic device using the optical matrix;

FIG. 7 illustrates an exemplary evolution strategy for generating a successive generation of configurations of optical elements to implement a desired photonic logic device;

FIG. 8 shows exemplary optical matrices configured to implement a photonic XOR logic gate and a photonic OR logic gate;

FIG. 9 shows an exemplary physical system that may be modeled using the present invention;

FIG. 10 shows an exemplary state model analogous to the physical system;

FIG. 11 shows an exemplary cube representing a physical segment of an optical channel;

FIG. 12 shows a cut-away drawing of a segment of an optical channel;

FIG. 13 shows the Cartesian coordinates, azimuth and elevation of each vertex of the cube and distances between faces of the cube;

FIG. 14 shows the cube superimposed upon a sphere with the geometric center of one face at the center of the sphere and vertices of the cube tangent to the surface of the sphere;

FIG. 15 shows an exemplary state model representative of a photon transfer process within a segment, representative of the present invention;

FIG. 16 shows exemplary Feynman diagrams representing interactions between photons and electrons;

FIG. 17 shows exemplary Feynman diagrams in which electrons traverse different paths from the same initial positions to the same final positions;

FIG. 18 shows an exemplary transition matrix for a cubic segment of an optical channel.

### DESCRIPTION OF THE PREFERRED EMBODIMENTS

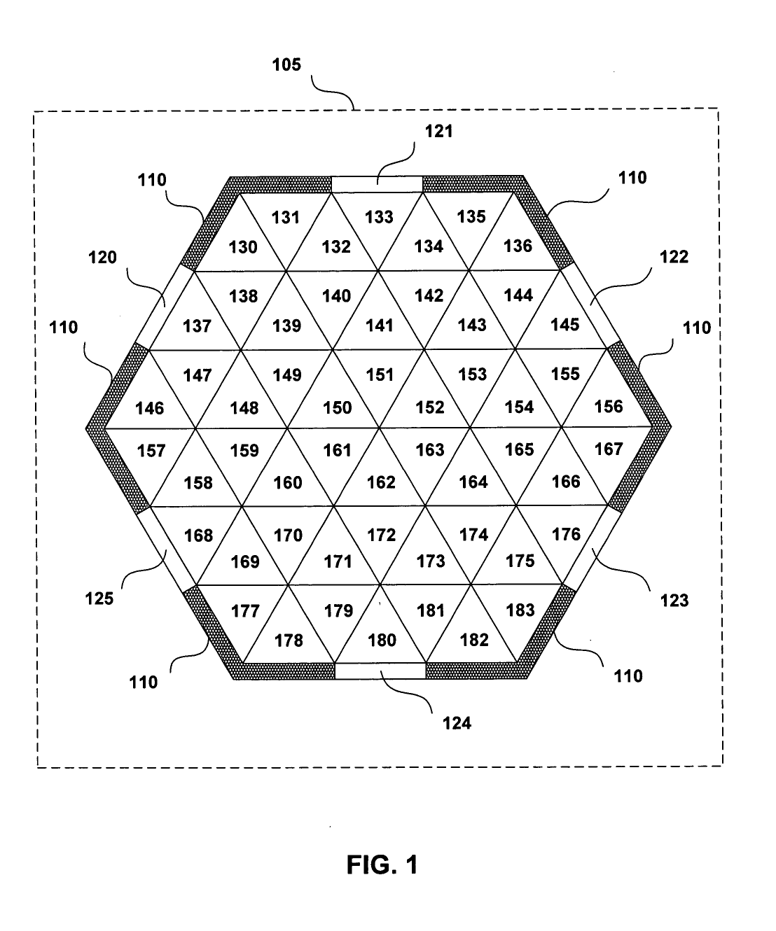

FIG. 1 shows an exemplary optical matrix 105 that may be configured as a photonic logic device, such as a smart photonic switch. The optical matrix 105 may include cladding material 110 that constrains light within an enclosed space. The optical matrix 105 may also include optical ports 120 to 125 that allow photonic signals to enter and exit the optical matrix 105 through the cladding material 110. The interior of the optical matrix 105 may be partitioned into optical elements 130 to 183 that transmit, absorb, diffract, reflect and/or refract light within the optical matrix 105. The optical matrix 105 may have a hexagonal topology, a square topology, a rhomboid topology, a triangular topology, an elliptic topology, or a topology that is not a regular geometric shape. Similarly, each element of the optical matrix 105 may be triangular, square or elliptic, and is not necessarily a regular geometric shape. The optical matrix 105 topology and shape of an element of the optical matrix 105 are only limited by the process used to map a configuration to an implementation, such as sub-micron lithography. Consequently, an optical matrix 105 may be a three-dimensional structure comprising multiple layers of optical material. Similarly, each element of the optical matrix 105 may be a three-dimensional structure, such as a sphere. In a preferred embodiment, the optical elements 130 to 183 may be smaller in linear dimension than a wavelength λ′ of a photonic signal of interest in the material of the optical matrix 105, such that an area of size λ′×λ′ may include surfaces of nine or more elements. A photon may enter the optical matrix 105 through one of the optical ports 120 to 125. The photon may then traverse a path through the optical elements 130 to 183 until the photon exits through one of the optical ports 120 to 125. Individual photons may traverse chaotic paths through the optical matrix 105 that are difficult to predict. However, when a plurality of photons traverse the optical matrix 105, each configuration of optical elements 130 to 183 produces a predictable interference pattern among the photons.

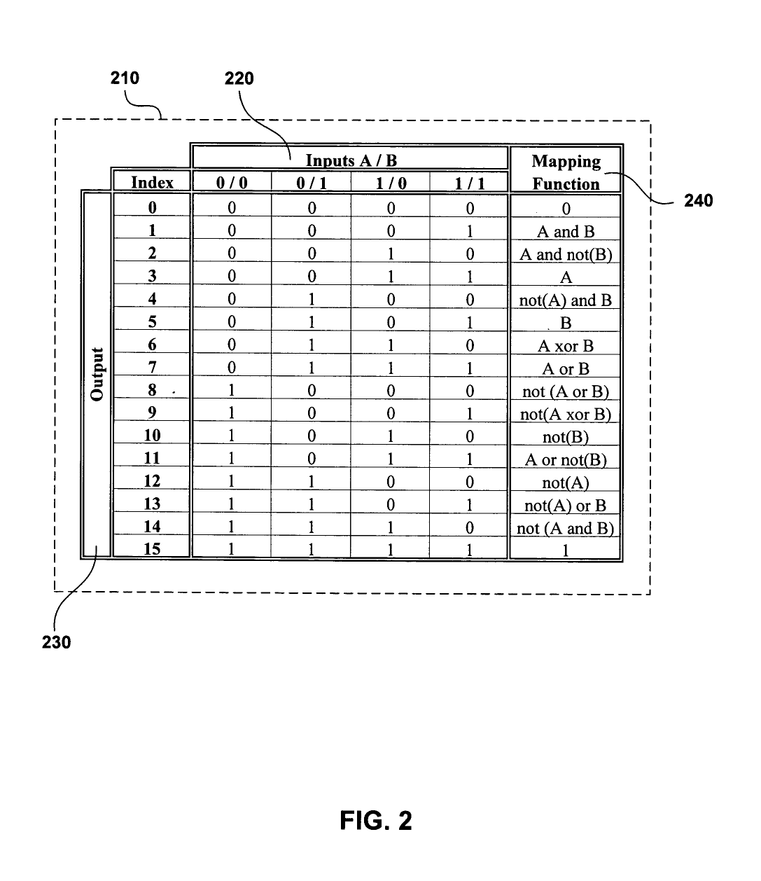

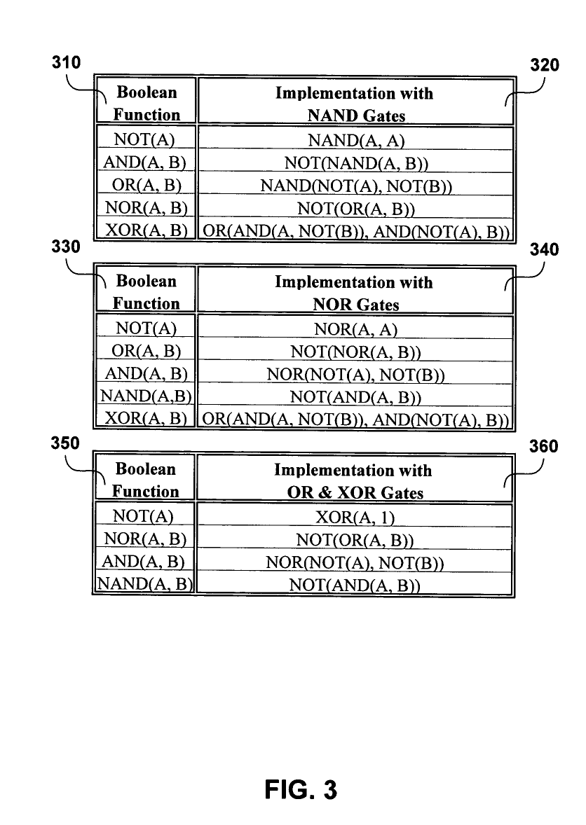

In electronic computers, logic functions may be implemented using Boolean gates. FIG. 2 shows the complete set 210 of Boolean mapping functions 240 that associate two input values A and B 220 to a set of output values 230. The Boolean mapping functions 240 are described using several Boolean operators selected from a set including AND, OR, NOT, NAND, NOR, and XOR operators. All Boolean functions may be implemented using a set of Boolean primitives, such as NAND gates or NOR gates. FIG. 3 shows several sets of Boolean functions, along with an exemplary implementation of each Boolean function using Boolean primitives. For example, each of the Boolean functions 310 including NOT, AND, OR, NOR and XOR is shown with a respective implementation 320 of the Boolean function 310 using NAND gates. Therefore any Boolean function may be implemented using only NAND gates. Also, each of the Boolean functions 330 including NOT, OR, AND, NAND and XOR is shown with a respective implementation 340 of the Boolean function 330 using NOR gates. Therefore any Boolean function may be implemented using only NOR gates. Finally, each of the Boolean functions 350 including NOT, NOR, AND and NAND is shown with a respective implementation 360 using OR and XOR gates. Therefore any Boolean function may be implemented using only OR and XOR gates.

Because any Boolean function may be implemented using only OR and XOR gates, any Boolean function may be implemented using a properly configured optical matrix 105. A first photonic signal A may be represented with the phasor equation:

A=|A|·e^{jωt}

a second photonic signal B may be represented with the phasor equation:

B=|B|e^{jωt}

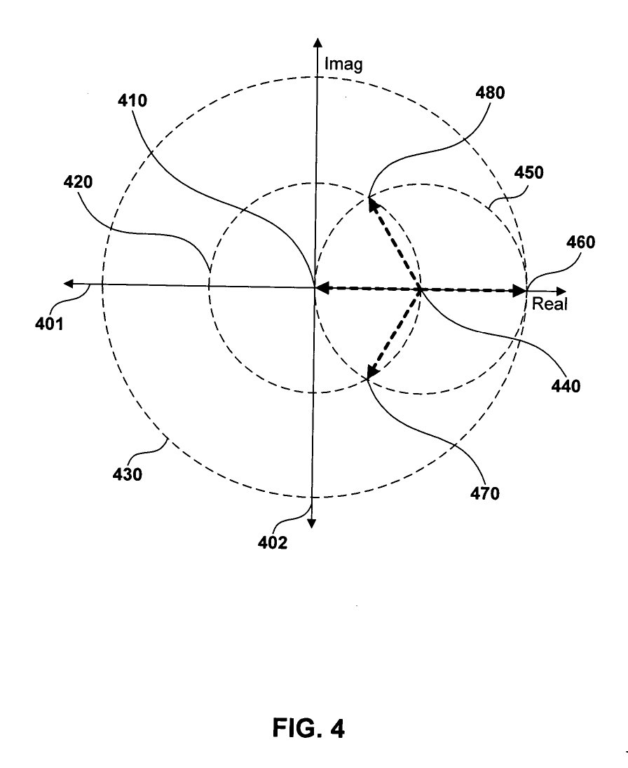

FIG. 4 shows an exemplary amplitude envelope that may result when the phasors are approximately equal in magnitude with a relative phase difference of 0 radians. For example, a real axis 401 and an imaginary axis 402 intersect at a first origin 410 of a first circle 420 having magnitude of one unit, and a second circle 430 having magnitude of two units. A unit vector projects from the origin 410 along the real axis 401 to a second origin 440 of a third circle 450 having magnitude of one unit. When the signals are completely in-phase, then the signals interfere constructively and the sum of the vectors 460 has a magnitude of two units, i.e.:

θ=2πn, where n is an integer→|A+B|=2

When the signals are completely out-of-phase, then the signals interfere destructively and the sum of the vectors 410 has a zero magnitude, i.e.:

θ=2πn±π, where n is an integer→|A+B|=0

When the first circle 420 and the third circle 450 intersect, then the sum of the vectors 470 and 480 has a unit magnitude, i.e.:

θ=2πn±2π/3, where n is an integer→+|A+B|=1

Consequently, the phase difference between the first signal and the second signal may be used to determine an interference pattern produced by the photonic signals.

The optical matrix 105 may implement a particular Boolean logic function by configuring the optical elements 130 to 183 to produce a phase difference between the optical ports 120 to 125. First, a phase-modulated photonic input signal A may be coupled to optical port 120 and a phase-modulated photonic input signal B may be coupled to optical port 121. A phase-modulated signal having a phase offset of zero radians may represent a Boolean “0” state and a phase offset of ±π radians may represent a Boolean “1” state. Second, unused optical ports 122 and 125 may be cladded to produce total internal reflection. Third, the amplitude-modulated result of the function may be sensed at optical port 123. A signal amplitude of zero, i.e. no signal, may correspond to a Boolean “0” state and a non-zero signal amplitude may correspond to a Boolean “1” state. Finally, optical port 124 may be coupled to an optical terminator (not shown).

For example, a photonic XOR gate may be implemented by configuring the optical elements 130 to 183 of the optical matrix 105. Four possible outputs are shown in Row 6 of FIG. 2 from the set 210 of Boolean functions; each output corresponds to one of four combinations of the two Boolean input signals, A and B:

1. if input A=0 and input B=0, then f(A, B)=0;

2. if input A=0 and input B=1, then f(A, B)=1;

3. if input A=1 and input B=0, then f(A, B)=1;

4. if input A=1 and input B=1, then f(A, B)=0.

Each “input” may be represented by a phasor and each “output” may be represented by an amplitude, producing the following set of simultaneous equations:

$$\begin{matrix} 1. \vert f ( \vert A \vert \cdot {ⅇ}^{j ω t} , \vert B \vert \cdot {ⅇ}^{j ω t} ) \vert = \frac{\vert A \vert - \vert B \vert}{2} \\ 2. \vert f ( \vert A \vert \cdot {ⅇ}^{j ω t} , \vert B \vert \cdot {ⅇ}^{j ( ω t + π )} ) \vert = \frac{\vert A \vert + \vert B \vert}{2} \\ 3. \vert f ( \vert A \vert \cdot {ⅇ}^{j ( ω t + π )} , \vert B \vert \cdot {ⅇ}^{j ω t} ) \vert = \frac{\vert A \vert + \vert B \vert}{2} \\ 4. \vert f ( \vert A \vert \cdot {ⅇ}^{j ( ω t + π )} , \vert B \vert \cdot {ⅇ}^{j ( ω t + π )} ) \vert = \frac{\vert A \vert - \vert B \vert}{2} \end{matrix}$$

One solution to this set of equations is the mapping function:

$$f ( A , B ) = \frac{1}{2} ( A + B \cdot {ⅇ}^{j ( 2 π n \pm π )} ) ,$$

where n is an integer.

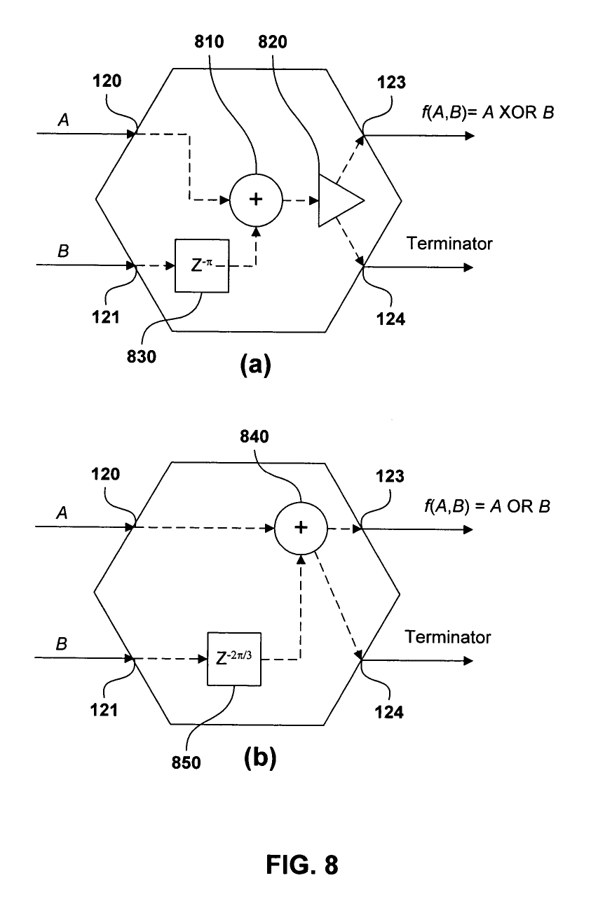

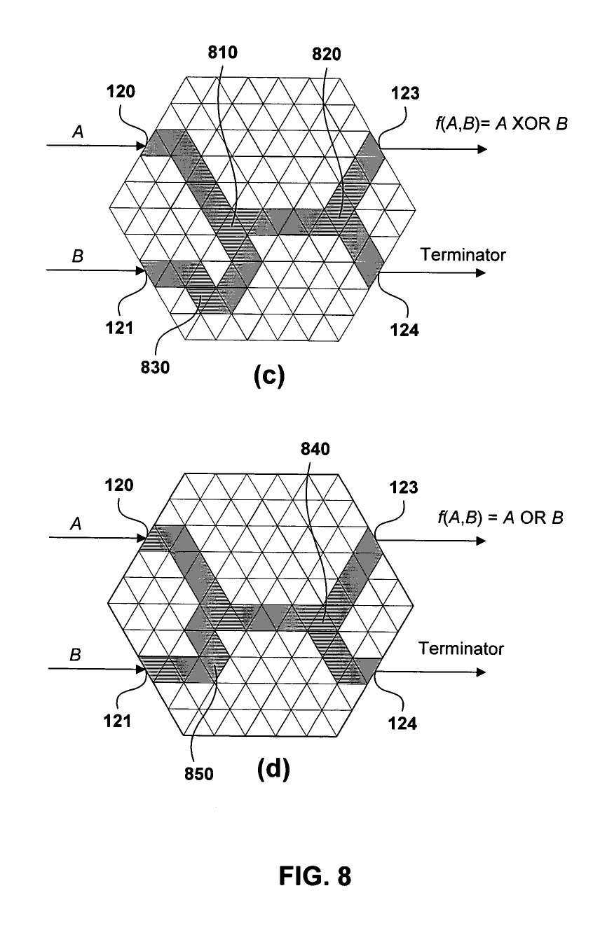

FIG. 8(a) shows an exemplary photonic XOR gate that implements this mapping function. The XOR gate includes an adder 810 that combines the input photonic signals from input optical ports 120 and 121. The adder 810 is coupled to a splitter 820 that divides the power of the signal from the adder, routing half of the signal to output optical port 123 and half of the signal to optical terminator port 124. The phase difference of ±π radians may be produced using different path lengths 830 between the input optical ports 120 and 121, and the adder 810. The phase shift produced by a difference in path length Δd may be determined using the equation:

$$Δθ = \frac{2 π \cdot Δ d}{{λ}^{′}} ,$$

where λ′ is the wavelength of the photonic signal in the material of the optical matrix 105. FIG. 8(c) shows an exemplary optical matrix 105 configured to implement the photonic XOR gate.

The photonic XOR gate may be used to route photonic signals, because an XOR function may be used to determine equivalence of two Boolean values. For example, a photonic signal may be received through input optical port 120 and a reference signal may be coupled to input optical port 121. The optical matrix may include a first output port 123 and a second output port 124. When the information encoded in the received photonic signal is not the same as the information encoded in the reference signal, as shown in combinations 1 and 4, then the encoded information produces a phase difference of ±π radians between the photonic signals, causing the received photonic signal to be directed to the first output port 124. When the information encoded in the received photonic signal is the same as the information encoded in the reference signal, as shown in combinations 2 and 3, then the encoded information produces a phase difference of zero (0) radians between the photonic signals, and the received photonic signal may be directed to the second output port 125.

A routing device may be implemented using different path lengths, corresponding to a phase difference of ±π radians, between the first output port 124 and the second output port 125. Alternatively, the desired behavior may be implemented by specifying a fitness metric that incorporates the behavior of both output port 124 and output port 125. Specifically, an appropriate fitness metric may be a weighted average of a fitness metric that identifies output port 124 as a Boolean XOR function of the input signals, and a fitness metric that identifies output port 125 as a Boolean NOT(XOR) function of the input signals.

A preferred embodiment of the routing device may include a termination port 126 for routing excess energy away from the optical matrix. For example, the amplitude of the transmitted output signal is proportional to the combination of both the received photonic signal and the reference signal. Therefore, the output signal may be amplified with respect to the received photonic signal. This may be desirable if the output photonic signal will be transmitted long distances through a fiber optic line. However, generally it is preferable to match the amplitude of the output photonic signal to the amplitude of the received photonic signal. Therefore, the additional energy of the reference signal may be directed to termination port 126, rather than directing the excess energy through output optical ports 124 or 125, or reflecting the energy through input optical ports 120 or 121. An appropriate fitness metric may be a weighted average of a fitness metric that identifies a desired amplitude at output port 124 as corresponding to a Boolean XOR function of the input signals, a fitness metric that identifies a desired amplitude at output port 125 as corresponding to a Boolean NOT(XOR) function of the input signals, and a fitness metric that identifies a desired amplitude at termination port 126 as proportional to a difference between amplitudes of the input signals at optical ports 120 and 121, and the output signals at optical ports 124 and 125.

Similarly, a photonic OR gate may be implemented by configuring the optical elements 130 to 183 of the optical matrix 105. Four possible outputs are shown in Row 7 of FIG. 2 from the set 210 of Boolean functions; each output corresponds to one of four combinations of the two Boolean input signals, A and B:

1. if input A=0 and input B=0, then f(A, B)=0;

2. if input A=0 and input B=1, then f(A, B)=1;

3. if input A=1 and input B=0, then f(A, B)=1;

4. if input A=1 and input B=1, then f(A, B)=1.

Each “input” may be represented by a phasor and each “output” may be represented by an amplitude, producing the following set of simultaneous equations:

$$\begin{matrix} 1. \vert f ( \vert A \vert \cdot {ⅇ}^{j ω t} , \vert B \vert \cdot {ⅇ}^{j ω t} ) \vert = \frac{\vert A \vert - \vert B \vert}{2} \\ 2. \vert f ( \vert A \vert \cdot {ⅇ}^{j ω t} , \vert B \vert \cdot {ⅇ}^{j ( ω t + π )} ) \vert = \frac{\vert A \vert + \vert B \vert}{2} \\ 3. \vert f ( \vert A \vert \cdot {ⅇ}^{j ( ω t + π )} , \vert B \vert \cdot {ⅇ}^{j ω t} ) \vert = \frac{\vert A \vert + \vert B \vert}{2} \\ 4. \vert f ( \vert A \vert \cdot {ⅇ}^{j ( ω t + π )} , \vert B \vert \cdot {ⅇ}^{j ( ω t + π )} ) \vert = \frac{\vert A \vert - \vert B \vert}{2} \end{matrix}$$

One solution to this set of equations is the mapping function:

$$f ( A , B ) = ( A + B \cdot {ⅇ}^{j ( 2 π n \pm \frac{2 π}{3} )} ) ,$$

where n is an integer.

FIG. 8(b) shows an exemplary photonic OR gate that implements this mapping function. The OR gate includes an adder 840 that combines the input photonic signals from input optical ports 120 and 121. The adder 840 is coupled to output optical port 123 and to optical terminator port 124. The phase difference of ±2π/3 radians may be produced using different path lengths 850 between the input optical ports 120 and 121 and the adder 840. Any Boolean function 350 may be implemented 360 by coupling the OR and XOR gates, as discussed previously with regard to FIG. 3. FIG. 8(d) shows an exemplary optical matrix 105 configured to implement the photonic OR gate.

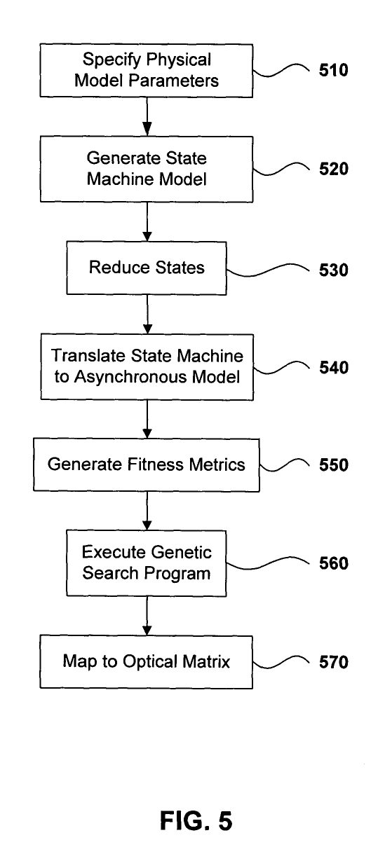

However, an optical matrix 105 may also be configured to generate an interference pattern that corresponds to any Boolean function 350 by properly configuring the optical elements 130 to 183. FIG. 5 shows an exemplary flowchart for configuring an optical matrix 105 as a photonic logic device. First, a user may specify physical model parameters for an implementation (step 510). For example, the user may specify one or more optical wavelengths of interest. The user may also specify a transmission factor, an absorption factor, a reflectivity factor, a refractive index and a speed of light in the medium of the optical matrix 105 for the one or more wavelengths of interest. The user may further specify and an optical matrix 105 topology, such as the hexagonal topology of FIG. 1. Then the user may generate a state machine model that represents the physical implementation (step 520). Next, the state machine model may be simplified by eliminating unused, equivalent, and redundant states (step 530), by methods such as those taught by Charles H. Roth, Jr. in Fundamentals of Logic Design, “Chapter 15—Reduction of State Tables & State Assignment” (1995). The sequential state machine model may also be translated into an asynchronous state model (step 540) by methods such as those taught in Roth's “Chapter 23—Analysis of Asynchronous Sequential Networks.” Then, the user may generate fitness metrics for a genetic search program (step 550) and execute the genetic program (step 560) to determine a “best” configuration for configuring the optical matrix 105 as a photonic logic device. Finally, the best configuration may be mapped for implementation in the optical matrix 105 (step 570), using masking techniques such as bitmap, raster or block-transfer graphics.

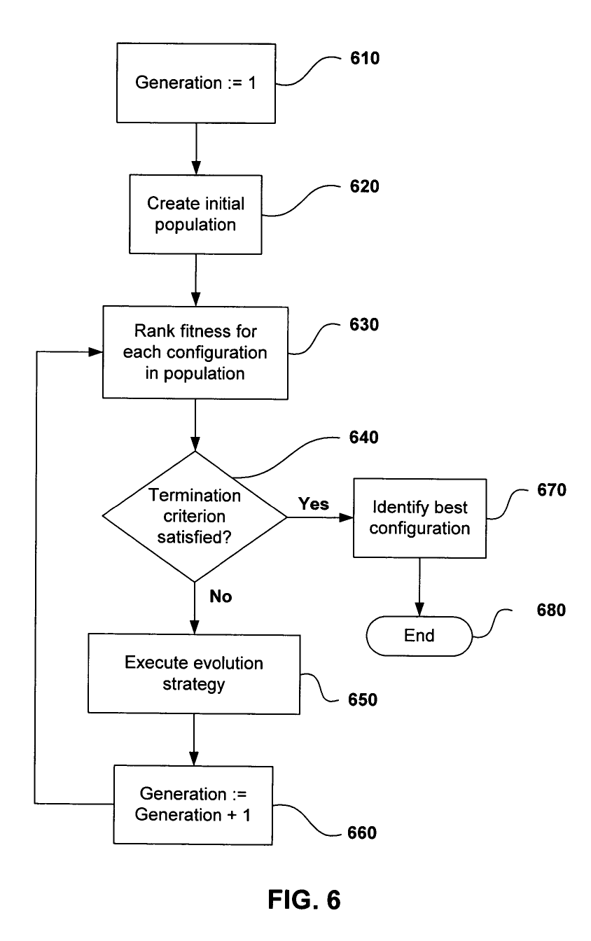

A genetic program may be used to determine the best possible configuration of the optical elements 130 to 183 of the optical matrix 105 to implement a particular logic function. FIG. 6 shows an exemplary flowchart for selecting a configuration of optical elements 130 to 183 to implement a desired logic function using the optical matrix 105. First, a counter variable is initialized to track the number of generations (step 610). Next, an initial population of possible configurations of the optical elements 130 to 183 is generated (step 620). Each configuration may be a software object comprising a “chromosome” field containing “alleles” that represent the configuration of each element in the optical matrix 105, an “evaluated” field that indicates whether the configuration has been evaluated with a fitness metric, and a “fitness” field that indicates the result of applying the fitness metric to the configuration. Each “allele” may also be a software object comprising information about how each element transmits, absorbs, diffracts, reflects and refracts a photonic signal at the one or more optical wavelengths of interest. The “evaluated” field may be used to avoid repeatedly evaluating the fitness of the same configuration, thereby reducing the computational effort required to evaluate a population, as compared to traditional genetic programs.

Then a fitness metric is applied to each configuration in the population and the configurations are ranked in order from most fit to least fit (step 630). The ranked population may be evaluated to determine whether a specified termination criterion is satisfied (step 640), such as by finding a perfect solution to the fitness metric or by exceeding a specified number of generations. If the termination condition is not satisfied, an evolution strategy may be executed to generate the next generation of the population (step 650). Finally, the generation counter variable is incremented (step 660) and the population is ranked in order from most fit to least fit (step 630). The search process repeats until one or more termination criteria are satisfied (step 640). Then the best configuration of optical elements 130 to 183 is identified (step 670) and the genetic program terminates (step 680).

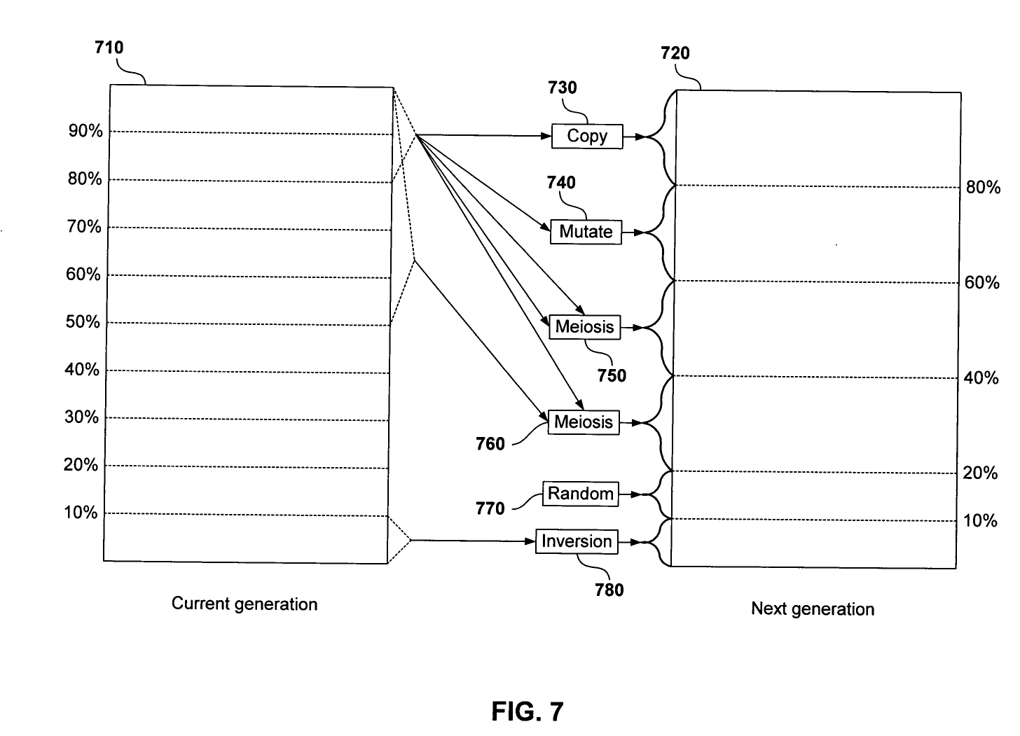

The process of generating desirable configurations may be guided using an evolution strategy. FIG. 7 illustrates an exemplary evolution strategy for generating successive generations of configurations of optical elements 130 to 183 to implement the desired photonic logic device. The exemplary evolution strategy illustrates the use of five transition operators to map the population of configurations from a current generation 710 to a next generation 720.

First, a copy 730 operator may be used to copy configurations from the current generation 710 to the next generation 720. For example, the fittest 20% of the configurations in the current generation 710 may be copied to the next generation 720. The copy 730 operator may be used to ensure that the fittest individuals of the current generation 710 are included in the next generation 720, thereby eliminating the problem of “back-sliding” that occurs with traditional genetic programs.

Second, the mutate 740 operator may be used to invert one or more elements in each configuration. For example, each of the configurations in the fittest 20% of the current generation 710 may be mutated and inserted into the next generation 720. The mutate operator 740 may be used to prevent stagnation among the fittest members of the population by introducing limited diversity into the fittest configurations of the current generation 710, before inserting the configurations into the next generation 720.

Third, the meiosis 750 operator may be used to recombine configurations using one-point or two-point crossover. For example, each configuration in the fittest 20% of the current generation 710 may be recombined using a two-point crossover with another configuration selected at random from the fittest 20% of the current generation 710. Then the recombined configurations may be inserted into the next generation 720. The meiosis 760 operator may also select configurations from different sections of the current generation 710 to enhance diversity in the next generation 720. For example, each configuration in the fittest 20% of the current generation 710 may be recombined using a two-point crossover with another configuration selected at random from the fittest 50% of the current generation 710. Then the recombined configurations may be inserted in the next generation 720. The meiosis operator 750 may be used to generate “child” configurations for the next generation 720 using the fittest “parent” configurations of the current generation 710.

Fourth, the random 770 operator may be used to generate configurations for the next generation 720 that have elements selected at random, with no particular relationship to configurations of the current generation 710. For example, 10% of the next generation 720 may be generated with the random 770 operator. The random 770 operator may be used to prevent stagnation of the population.

Fifth, the inversion 780 operator may be used to invert all elements in a configuration of the current generation 710 before inserting the inverted configuration into the next generation 720. For example, the least fit 10% of the current generation 710 may be inverted and inserted into the next generation 720. The worst configurations of the current generation 710 may be converted into highly fit configurations for the next generation 720 by using the inversion operator 780 to invert optical elements that cause the configuration to be undesirable.

A genetic program may use a fitness function to evaluate each configuration of the optical matrix 105. A fitness function may comprise a weighted average of the error margins resulting from representing a desired logic function using a particular configuration of the elements 130 to 183 of the optical matrix 105. The interference pattern produced by a particular configuration of optical elements 130 to 183 may be determined by using a raytracing engine to determine the output of the optical matrix 105 in response to the four input conditions. For example, a particular configuration may produce the following set of responses:

1. |f(|A|·e^{jωt},|B|·e^{jωt})|=C

2. |f(|A|·e^{jωt,|B|·e}^{j(ωt+π)})|=D

3. |f(|A|·e^{jωt+π)},|B|·e^{jωt})|=E

4. |f(|A|·e^{j(ωt+π)},|B|·e^{j(ωt+π)})|=F

The error terms for an XOR photonic gate are:

$$\begin{matrix}{ϵ}_{1} = \vert C - \frac{\vert A \vert - \vert B \vert}{2} \vert , \\ {ϵ}_{3} = \vert E - \frac{\vert A \vert + \vert B \vert}{2} \vert ,\end{matrix} \begin{matrix}{ϵ}_{2} = \vert D - \frac{\vert A \vert + \vert B \vert}{2} \vert \\ {ϵ}_{4} = \vert F - \frac{\vert A \vert + \vert B \vert}{2} \vert\end{matrix}$$

The fitness function may be a function of the mean squared error terms, for example:

$$Fitness = 1 - \frac{{ϵ}_{1}^{2} + {ϵ}_{2}^{2} + {ϵ}_{3}^{2} + {ϵ}_{4}^{2}}{4 \cdot ( \vert A \vert + \vert B \vert )}$$

In the alternative, the fitness function may be a fuzzy logic function of the error terms, for example:

$$Fitness = 1 - \frac{2 \cdot max \{ {ϵ}_{1} , {ϵ}_{2} , {ϵ}_{3} , {ϵ}_{4} \}}{\vert A \vert + \vert B \vert}$$

The response of a particular configuration of optical elements 130 to 183 of the optical matrix 105 to input signals A and B may be determined by raytracing the path of photons through the optical matrix 105. However, traditional raytracing methods are sub-optimal for several reasons. First, traditional raytracing methods model photons by assuming that they behave as particles on definite paths. However, at scales approaching 1.0×10⁻¹⁰ meters the paths of photons are highly chaotic. Second, by modeling photons as particles, traditional raytracing methods fail to incorporate the phase properties that produce diffraction, polarization, refraction and reflection effects. Third, traditional raytracing methods model reflections by tracing the paths of photons through time. However, within an optical matrix 105, paths may exist that permit an infinite number of reflections. Thus, traditional raytracing models would be unable to determine the paths of the photons. In addition, traditional raytracing methods are notoriously slow and are intended to produce photo-realistic results, not engineering-quality results. A preferred method of modeling the paths of photons may use a technique based on probabilistic paths through 4-dimensional space and time, where each possible path has an associated probability that represents the likelihood that a photon will traverse the path. Hereinafter, the term “tessic” is used to refer to a path through 4-dimensional space and time that is associated with a probability of occurrence.

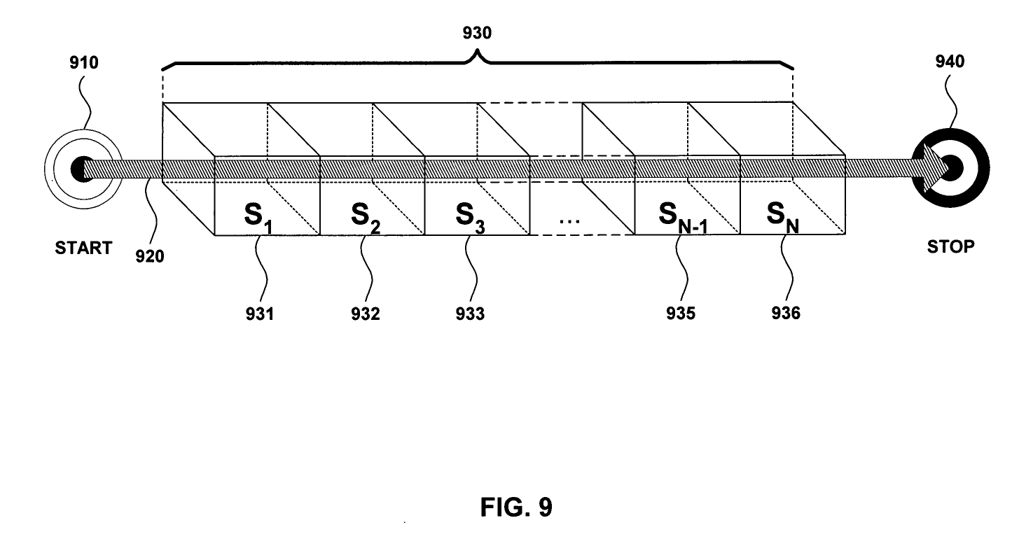

A tessic path-tracing system may be used to determine the response of a physical system to photonic signals. FIG. 9 shows an exemplary physical system that may be modeled using the present invention. The system may contain a light source 910, such as a laser emitter. The light source 910 may project a photonic signal 920 through an optical channel 930 and into an optical terminator 940. The optical channel 930 may be partitioned into N segments S₁ 931 to S_{N} 936, where S₁ 931 is the segment closest to the light source 910 and S_{N} 936 is the segment closest to the optical terminator 940. Photons produced by the light source 910 may traverse a path through the N segments S₁ 931 to S_{N} 936 of the optical channel 930 to reach the optical terminator 940.

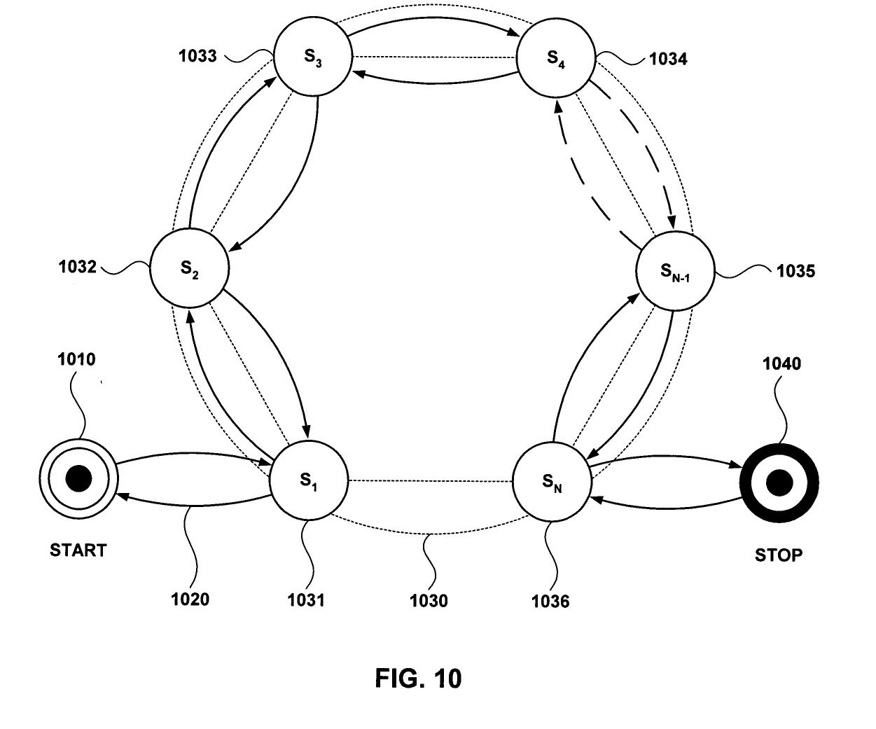

A state model may be used to represent the physical process. FIG. 10 shows an exemplary state model analogous to the physical process. The state model may include a signal source 1010, analogous to the light source 910, and a signal sink 1040, analogous to the optical terminator 940. The model may further include a ring 1030 of states S₁ 1031 to S_{N} 1036, analogous to the segments S₁ 931 to S_{N} 936 of the optical channel 930, where the S₁ 1031 state is coupled to the signal source 1010 and the S_{N} 1036 state is coupled to the signal sink 1040. A tessic signal path 1020 may couple the signal source 1010, through each of the signal states S₁ 1031 to S_{N} 1036 in turn, to the signal sink 1040.

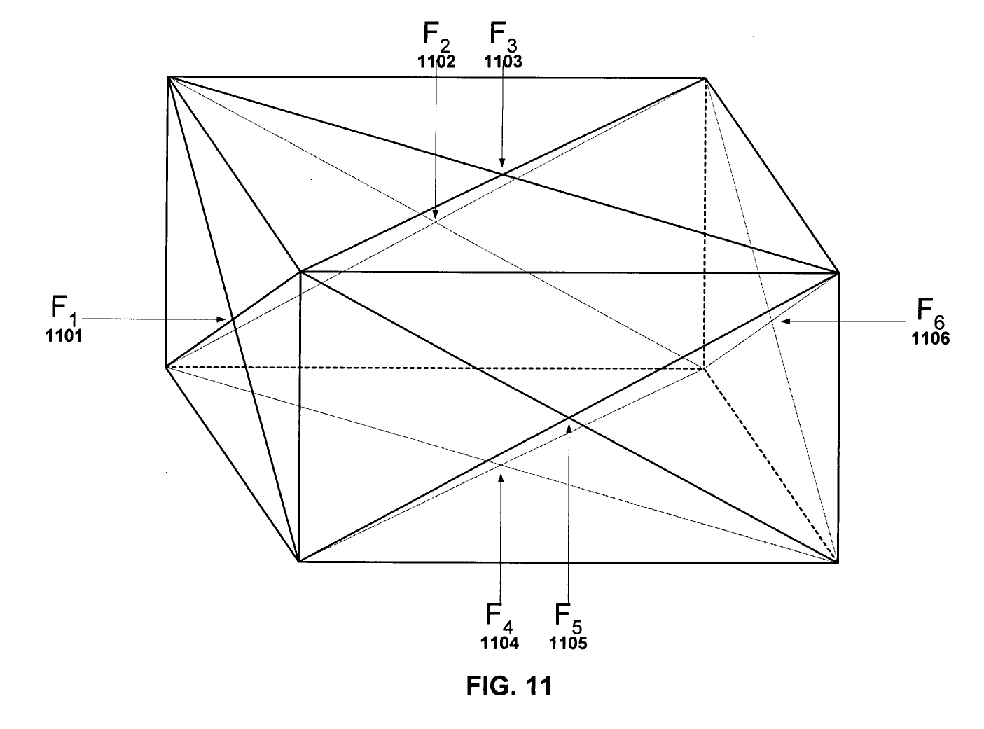

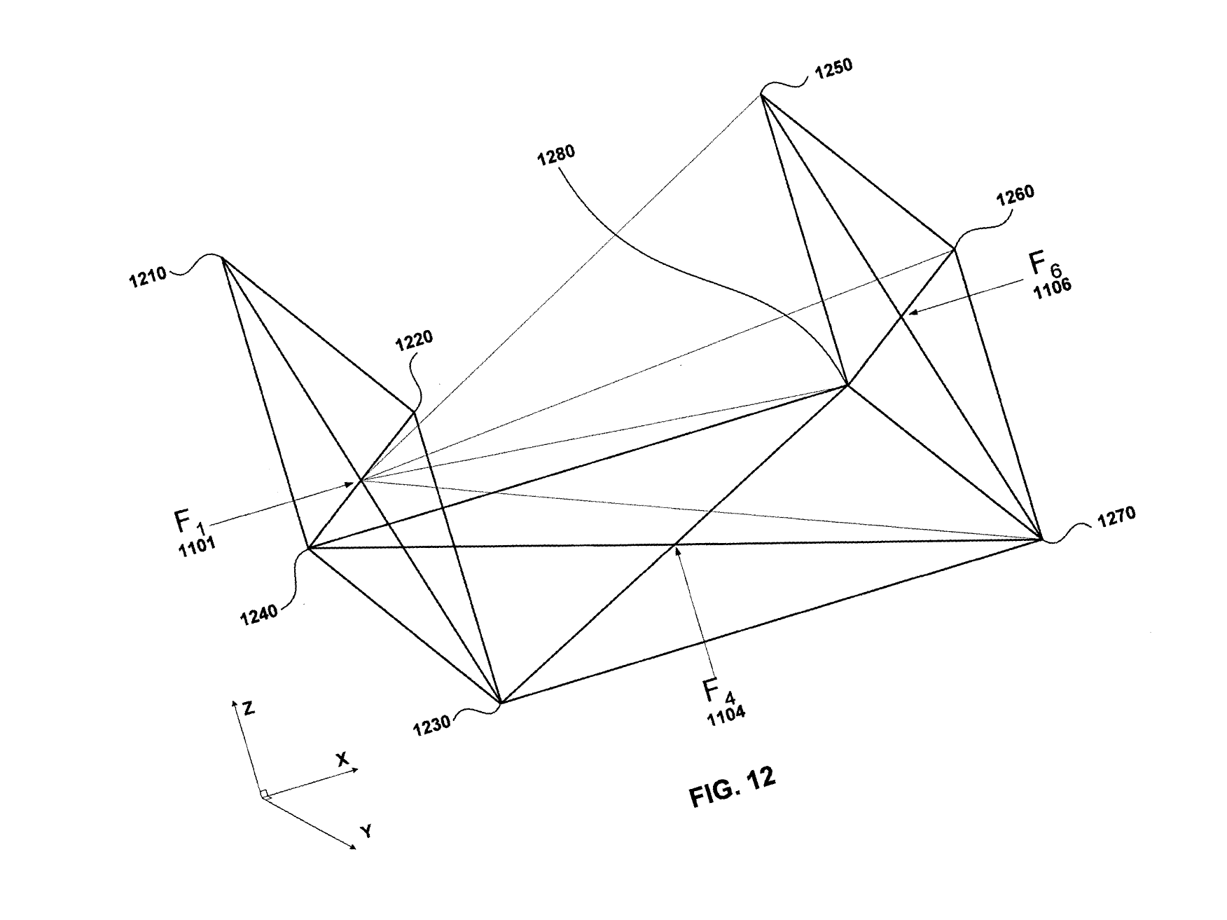

A segment may correspond to the smallest element of a physical process, such as the optical channel 930, that is modeled. Segments are preferably modeled using shapes with fractal properties that facilitate scaling, such as a cube. A cube may be subdivided into additional cubes. Similarly, the triangular optical elements 130 to 183 of FIG. 1 may be grouped into larger triangles. FIG. 11 shows an exemplary cube representing a physical segment of the optical channel 930. The segment may be represented by a cube having six faces F₁ 1101 to F₆ 1106. Face F₁ 1101 is closest to the light source 910 and face F₆ 1106 is closest to the signal sink 940. Face F₁ 1101 adjoins faces F₂ 1102 to F₅ 1105 and opposes face F₆ 1106. Face F₂ 1102 adjoins faces F₁ 1101, F₃ 1103, F₄ 1104 and F₆ 1106, and opposes face F₅ 1105. Face F₃ 1103 adjoins faces F₁ 1101, F₂ 1102, F₅ 1105, and F₆ 1106, and opposes face F₄ 1104. Face F₄ 1104 adjoins faces F₁ 1101, F₂ 1102, F₅ 1105, and F₆ 1106, and opposes face F₃ 1103. Face F₅1105 adjoins faces F₁ 1101, F₃ 1103, F₄1104 and F₆ 1106, and opposes face F₂ 1102. Face F₆ 1106 adjoins faces F₂ 1102 to F₅ 1105 and opposes F₁ 1101.

The probability associated with a particular tessic path is partially a function of the geometry of each segment. FIG. 12 shows a cut-away drawing of a segment of the optical channel 930. Three of the faces (F₂ 1102, F₃ 1103 and F₅ 1105) have been removed to better illustrate the geometry between faces F₁ 1101, F₄ 1104 and F₆ 1106. When a photon enters the segment through face F₁ 1101, its momentum may carry it until it coincides with another face F₂ 1102 to F₆ 1106. The reference origin is defined as the geometric center of face F₁ 1101 and the variable x is used to represent the length of each side of the cube. FIG. 12 shows line segments radiating from the geometric center of face F₁ 1101 to each vertex (1250 through 1280) of the opposing face F₆ 1106.

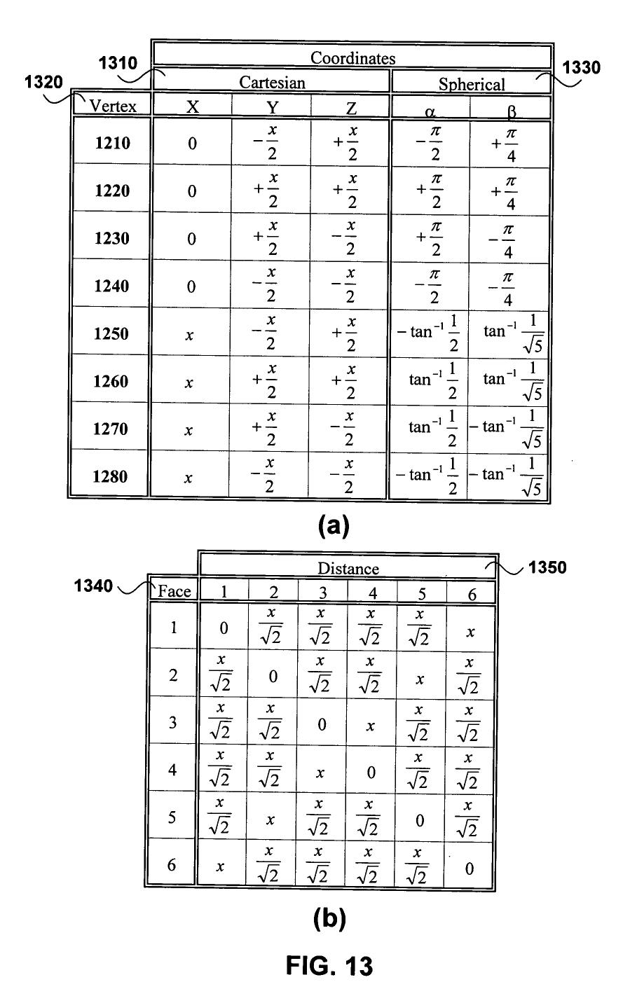

The cube has eight vertices 1210 through 1280, as shown in FIG. 12. Differential Cartesian coordinates 1310 for each vertex 1320 of the cube may be determined using differential geometry, as shown in FIG. 13(a). Next, by defining α as the azimuth and β as the elevation, the spherical coordinates 1330 from the geometric center of face F₁ 1101 to each vertex 1320 may be calculated from the differential Cartesian coordinates 1310. Similarly, distances (Δd) 1350 between geometric centers of respective faces 1340 of the cube may be calculated from the differential Cartesian coordinates 1310 for each vertex 1320, as shown in FIG. 13(b). When an element has fractal properties, the dimensions of the element scale linearly both in the spatial dimensions and the temporal dimension, i.e., the time (Δt) required for a photon to propagate between geometric centers of respective faces, as computed using the equation: Δt=Δd/c′(λ), where c′(λ) is the speed of the photonic signal in the material of the optical matrix 105 at the wavelength λ of the photonic signal, and Δd 1350 is the distance between geometric centers of respective faces 1340 of the cube.

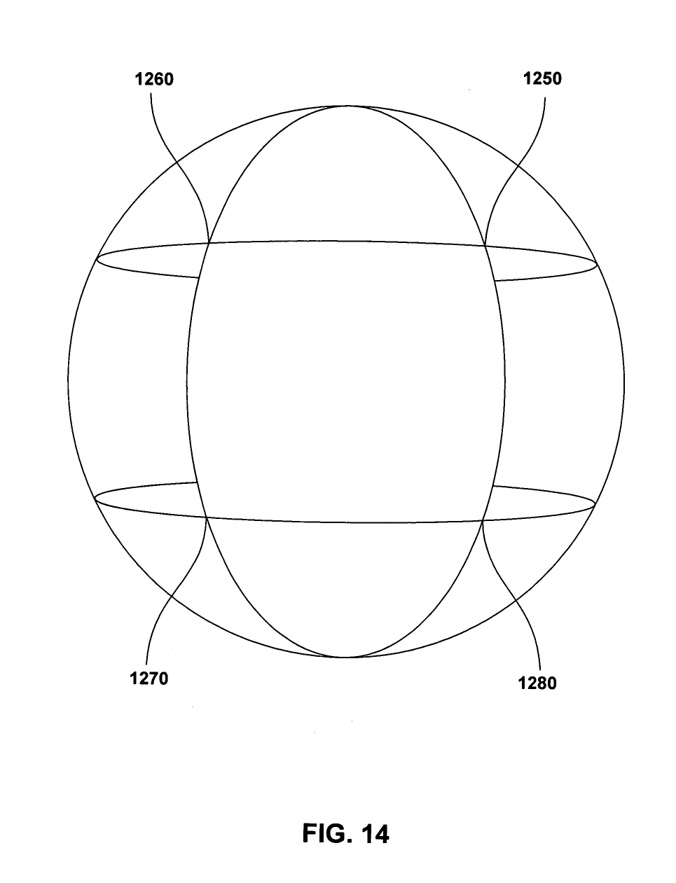

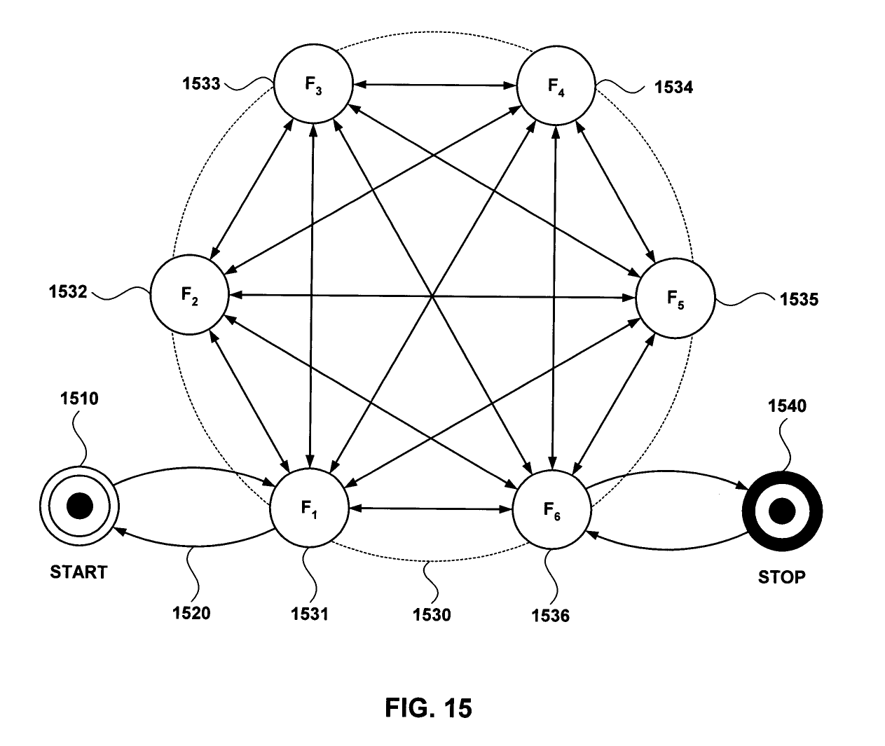

The probability that a photon will intersect a face F₁ 1101 to F₆ 1106 of the cube is a function of the angles to the vertices 1210 through 1280 of the cube viewed from the location of the photon. When a photon is emitted from the light source 910, it may enter the first segment S₁ 931 through face F₁ 1101. The probability that the photon will intersect a particular face of the cube is a function of the angles to the face of the cube, as viewed from the location of the photon. FIG. 14 shows the cube superimposed upon a sphere with the geometric center of face F₁ 1101 at the center of the sphere and vertices 1250 through 1280 of the cube tangent to the surface of the sphere. The vertices of face F₆ 1106 (1250 through 1280) of the cube define a spheric section. The photon may be modeled as having energy with a uniformly distributed angular orientation; i.e., an isotropic radiation pattern.

Each element of the optical matrix 105 may be modeled using coupled-dipole antennas having an effective linear dimension less than the wavelength of an electromagnetic wave of interest. The coupled-dipole antenna model may be consistent with physical reality to dimensions as small as 1.0×10⁻¹⁰ meters, approximately an atomic radius, because all chemically stable compounds have an even number of electrons, corresponding to the coupled-dipole antennas. Deviations from an isotropic radiation pattern may be modeled using transition probabilities, which correspond to the observed flux density of an electromagnetic wave radiated from an antenna.

The probability that the photon will intersect a face F₂ 1102 to F₆ 1106 of the cube is proportional to the ratio of the surface area of the spheric section to the surface area of the sphere and may be calculated using the equation:

$${p}_{i} ∝ \frac{{\int }_{{α}_{1}}^{{α}_{2}} {\int }_{{β}_{1}}^{{β}_{2}} cos β \cdot ⅆ β \cdot ⅆ α}{4 π} , i = 2 … 6$$

The probability that the photon will intersect face F₆ 1106 of the cube may be calculated using the equation:

$${p}_{i} ∝ \frac{\vert α \cdot sin β \vert}{π} , i = 6$$

The probability that the photon will intersect one of the adjoining faces F₂ 1102 to F₅ 1105 of the cube may be calculated using the equation:

$${p}_{i} ∝ \frac{π - \vert α \cdot sin β \vert}{4 π} , i = 2 … 5$$

The probabilities are proportional to the ratios of surface areas when there is a finite probability that the photon may be absorbed and emitted at a later time.

When the material of the optical channel 930 has phosphorescent or fluorescent properties, the physical system may store photons for relatively long periods of time. Phosphorescent materials may trap a photon for longer than 1.0×10⁻⁸ seconds before emitting the photon with an isotropic dispersion. Fluorescent materials may absorb a photon at one frequency and hold the photon for longer than 1.0×10⁻⁸ seconds before emitting a photon at a different frequency with an isotropic dispersion. A time delay in excess of 1.0×10⁻⁸ seconds between the time the photon is absorbed and the time the photon is emitted is significant because a photon may otherwise travel approximately 3.0 meters in a period of 1.0×10⁻⁸ seconds, as computed using the equation:

Δd=Δt·c′(λ), where c′(λ) is the speed of the photonic signal in the material of the optical matrix 105 at the wavelength λ of the photonic signal. Materials having phosphorescent or fluorescent properties may be represented by assigning a non-zero probability to the tessic path from face F₁ 1101 back to itself. That is,

P₁>0. i=1.

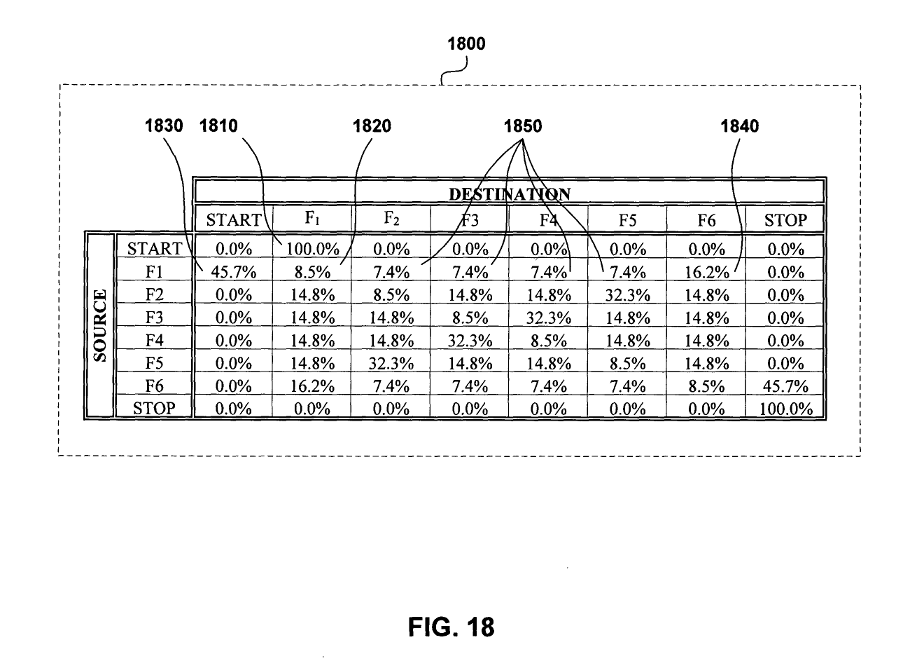

FIG. 18 shows an exemplary tessic transition matrix 1800 for the cube. The first row of the transition matrix 1800 shows a probability 1810 that a photon from the light source 1510 will intersect face F₁ 1101 of the cube is set to 100%. The second row of the transition matrix 1800 shows a probability 1820 of 8.5% that a photon will be absorbed by face F₁ 1101 to be emitted at a later time. The probability 1820 that the photon will be absorbed is actually a function of the phosphorescent or fluorescent properties of the material used to construct the optical matrix 105 and may be set accordingly. The probability 1830 that the photon will exit face F₁ 1101 and reflect toward the light source 1510 is set at 45.7%, corresponding to half of the probability that the photon is not trapped by an electron. The probability 1840 that the photon will intersect face F₆ 1106 is approximately 35.4% of the remaining probability, i.e. 16.2%. The probability 1850 that the photon will intersect one of the other faces F₂ 1102 to F₅ 1105 may be computed by dividing the remaining probability into four equal parts, i.e. 7.4%. The process is repeated to complete the remaining rows of the transition matrix 1800.

A tessic tracing method may be used to model the path a photon traverses through a segment. FIG. 15 shows an exemplary state model representative of the photon transfer process within a segment, representative of the present invention. The segment model may include a signal source 1510, analogous to the light source 910 and a signal sink 1540, analogous to the optical terminator 940. The model may further include a ring 1530 of states F₁ 1531 to F₆ 1536, where the F₁ 1531 state is coupled to the signal source 1510 and the F₆ 1536 state is coupled to the signal sink 1540. Each state F₁ 1531 to F₆ 1536 is coupled to every other state with paths. For example, a photon at state F₂ 1532 may traverse a tessic path to any one of states F₁ 1531 and F₃ 1533 to F₆ 1536. Additionally, each state is coupled to itself with a tessic path; for example, there is a path from state F₂ 1532 back to the same state F₂ 1532. This path represents the possibility that a photon will remain within face F₂ 1102 due to luminescence or fluorescence. A tessic signal path 1520 may couple the signal source 1510 through each of the signal states F₁ 1531 to F₆ 1536 in turn, to the signal sink 1540.

In general, photon transfer processes are chaotic and highly non-linear. When the light source 910 is activated, photons may propagate through the optical channel 930 to the optical terminator 940. Some photons may reflect from face F₁ 1101 of segment S₁ 931 and face F₆ 1106 of segment S_{N} 936. Photons may be absorbed by electrons and then emitted later, delaying the photons as they traverse the optical channel 930. If the light-source 910 emits a photonic signal with a constant power envelope, the optical flux density within the optical channel 930 will converge to a steady state response.

By definition, at steady-state the expected value of the number of photons entering the optical channel 930 is in equilibrium with the number of photons exiting the optical channel 930 over one period of the photonic signal. The number of photons expected to enter and to exit the optical channel 930 are exactly equal, therefore the optical flux density is constant. Non-linear distortion effects, such as passive intermodulation, are caused by amplitude-modulation to amplitude-modulation effects and amplitude-modulation to phase-modulation effects. When the optical flux density is constant, the amplitude of the photonic signal is constant as well. Thus, at steady-state any nonlinearities in the optical channel 930 will not produce non-linear distortion effects that distort the photonic signal and the solution to the non-linear process converges to the same result as a representative linear process. Consequently, at steady-state the tessic transition matrix 1800 may be used as a transition matrix for a Markov process that represents the optical channel 930. The Markov process may then be solved to determine the channel response using linear algebra methods, such as those taught in the paper “The Mean Power Spectral Density of Markov Chain Driven Signals” by P. Galko and S. Pasupathy, IEEE Trans. on Info. Theory, November 1981, pp. 746-54; the paper is incorporated herein by reference.

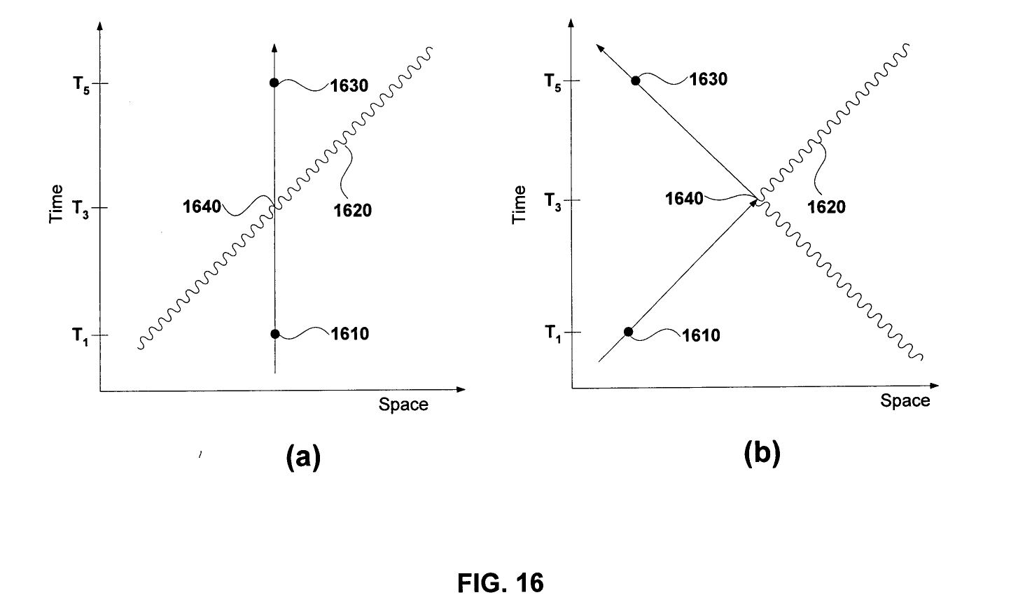

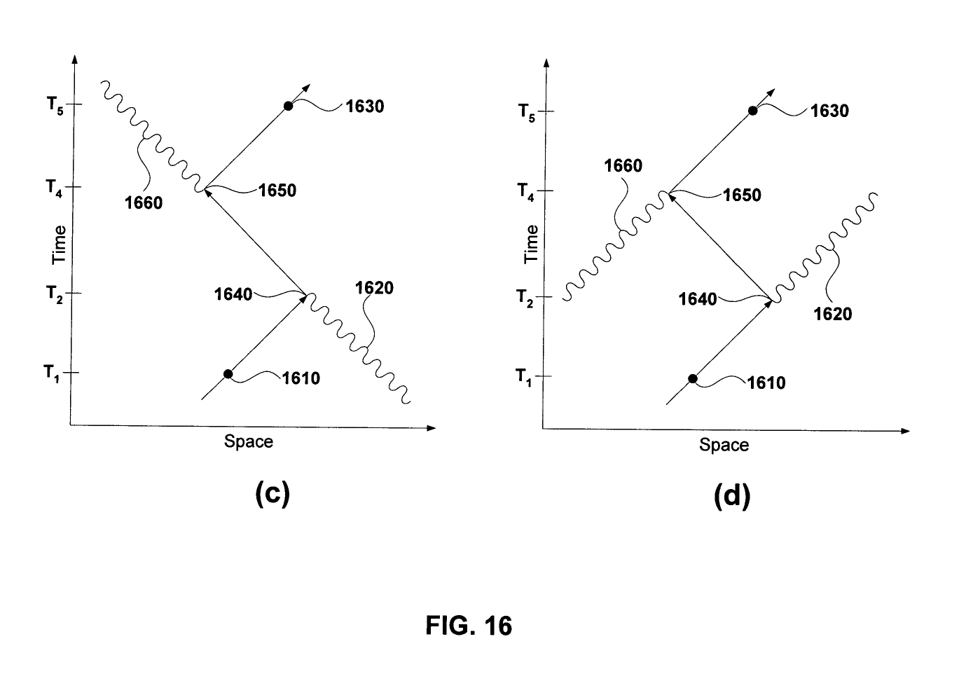

The expected value of the time required to traverse a tessic path between respective faces 1340 of the cube may be proportional to the time required to traverse the distance between geometric centers. The relation is determined by Dirac's constant (approximately 1.00115965221), because photons may traverse an indirect path between the geometric centers due to couplings between photons and electrons. The tessic path-tracing system may incorporate logic regarding the many different ways that real photons may interact with electrons to produce significant optical interference and scattering effects such as diffraction, polarization, refraction and reflection. FIG. 16 shows four exemplary Feynman diagrams representing interactions between photons and electrons. First, a photon may coincide with the electron without being affected. In FIG. 16(a), an electron has position 1610 at time T₁. A photon 1620 intersects the path of the electron at position 1640 and time T₃, but neither the photon 1620 nor the electron is affected. The momentum of the electron carries it to position 1630 at time T₅.

Second, a photon may coincide with the electron and be reflected. In FIG. 16(b), an electron has position 1610 at time T₁ A photon 1620 intersects the path of the electron at position 1640 and time T₃, and the photon 1620 and the electron are reflected. The momentum of the electron carries it to position 1630 at time T₅.

Third, the electron may absorb a photon and emit the photon at a later time. In FIG. 16(c), an electron has position 1610 at time T₁. A photon 1620 intersects the path of the electron at position 1640 and time T₂, and the photon 1620 is absorbed by the electron, altering the electron's momentum. At position 1650 and time T₄, the electron emits a photon 1660, again altering the electron's momentum. The emitted photon 1660 is not necessarily the same photon 1620 that was absorbed. The momentum of the electron carries it to position 1630 at time T₅.

Fourth, the electron may emit a photon and then absorb a photon at a later time. In FIG. 16(d), an electron has position 1610 at time T₁. At position 1640 and time T₂, the electron emits a photon 1620, altering the electron's momentum. A photon 1660 intersects the path of the electron at position 1660 and time T₄, and the photon 1660 is absorbed by the electron, altering the electron's momentum. A virtual photon is a photon emitted at a time T₂ earlier than the time T₄ when it was absorbed. The momentum of the electron carries it to position 1630 at time T₅.

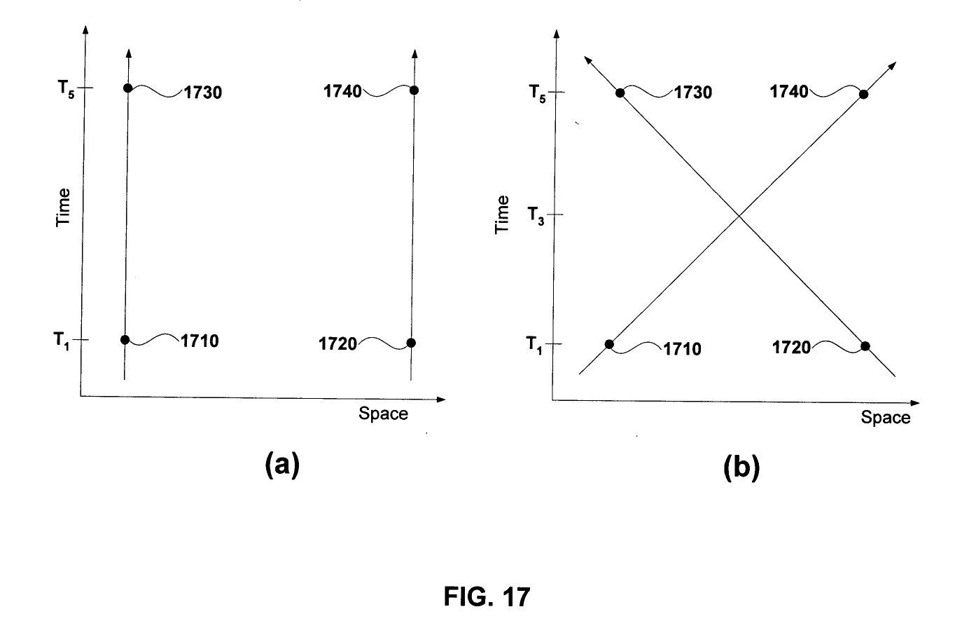

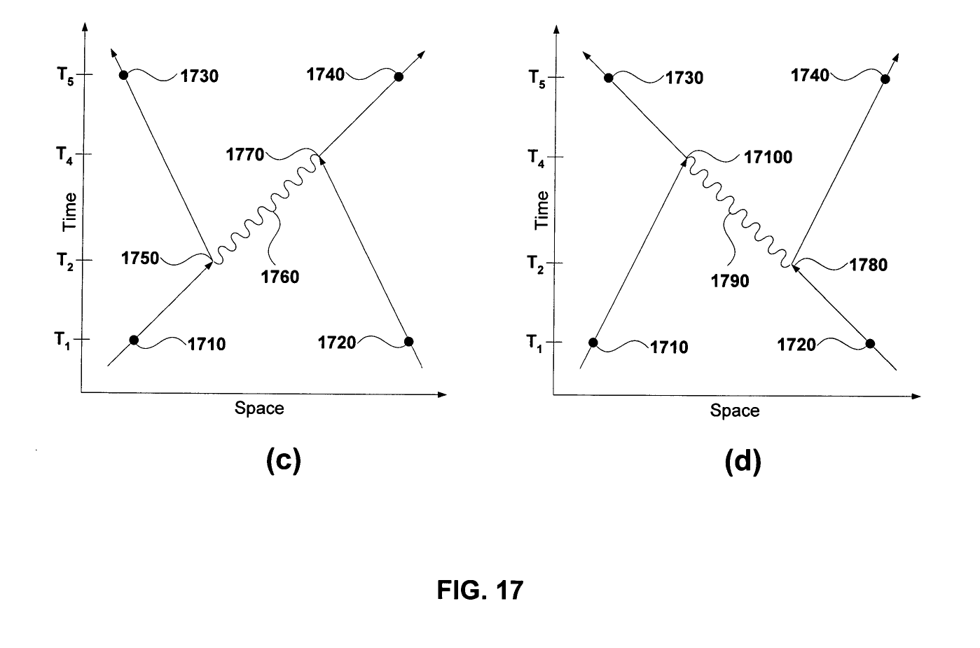

In addition to photon-electron interactions, there are many possible paths that may carry an electron from the same initial position to the same final position. FIG. 17 shows exemplary Feynman diagrams in which two electrons start from the same locations 1710 and 1720 in space at time T₁. From there, the electrons take different paths that nevertheless end at the same locations 1730 and 1740 in space at time T₅. The paths of the electrons are illustrated as a function of space and time, where the horizontal axis represents displacement in space and the vertical axis represents displacement in time.

The first panel shows a scenario in which the electrons do not move relative to each other and remain in the same position because no event occurs to cause the electrons to move. In FIG. 17(a), the two electrons have positions 1710 and 1720 at time T₁. No event occurs to alter the position or momentum of the electrons; thus, the two electrons retain positions 1730 and 1740 at time T₅.

The second panel shows a scenario in which the electrons move relative to each other and the momentum of the electrons causes them to exchange positions. In FIG. 17(b), the two electrons have positions 1710 and 1720 at time T₁. The electrons have momentum carrying them toward positions 1730 and 1740. As shown, the tessic paths may intersect at position 1725 and time T₃. However, the drawing is a 2 dimensional representation of a 4-dimensional path and the electrons may or may not coincide at position 1725 and time T₃. If the electrons do not coincide, then the momentum of the electrons may be unaffected. That is, one electron may start at position 1710 at time T₁ and its momentum may carry it to position 1740 at time T₅. The other electron may start at position 1720 at time T₁ and its momentum may carry it to position 1730 at time T₅.

If the electrons do coincide, then they may reflect off of each other. That is, the electrons may have positions 1710 and 1720 at time T₁. At position 1725 and time T₃, the electrons may repel each other, changing the momentum of both electrons. The first electron may start at position 1710 at time T₁ and reflect away from the second electron at position 1725 and time T₃. Then the first electron's momentum may carry it to position 1730 at time T₅. Similarly, the second electron may start at position 1720 at time T₁ and reflect away from the first electron at position 1725 and time T₃. Then the second electron's momentum may carry it to position 1740 at time T₅. Thus, whether or not the electrons coincide at position 1725 and time T₃, the tessic paths may start at positions 1710 and 1720 at time T₁ and end at positions 1730 and 1740 at time T₅.

The third panel shows a scenario in which the electrons exchange a photon. In FIG. 17(c), the two electrons have positions 1710 and 1720 at time T₁. The electrons have momentum that carries them toward positions 1730 and 1740. At time T₂, one of the electrons emits a photon 1760 and changes trajectory toward position 1730. At time T₄, the other electron absorbs the photon 1760 and changes trajectory toward position 1740. The new trajectories of the electrons carry them to positions 1730 and 1740 at time T₅.

The fourth panel shows a scenario in which the electrons exchange a virtual photon. In FIG. 17(d), the two electrons have positions 1710 and 1720 at time T₁. The electrons also have momentum carrying them toward positions 1730 and 1740. At time T₂, one of the electrons absorbs a photon 1790 and changes trajectory toward position 1740. At time T₄, one of the electrons emits the photon 1790 and changes trajectory toward position 1730. The new trajectories of the electrons carry them to positions 1730 and 1740 at time T₅. In this scenario, the virtual photon is absorbed before it is emitted and therefore appears to move backwards through time. A virtual photon scenario may occur when an electron captures a photon in one simulation frame, then releases the photon and captures another photon within a later simulation frame. Consequently, the tessic path of FIG. 17(d) is possible, as is permitted by the tessic tracing method.

Many possible photon-electron interactions may produce indistinguishable outcomes, as noted by Richard Feynman in QED: The Strange Theory of Light and Matter, p. 115-19 (1985). Consequently, a tessic path-tracing system may model interactions of photons and electrons using probabilistic operators, such as the expected value operator. When used in combination with efficient scaling techniques, such as fractals, the tessic-path tracing system may allow efficient modeling, simulation, analysis and design of chaotic and quasi-random systems. With regard to the methods and apparatuses disclosed herein, terms such as “light”, “photonic signal”, “fiber optic” and “optical matrix” may refer to any electromagnetic wave. The terms are not to be limited to the visible portion of the spectrum; a preferred embodiment for the optical matrix 105 may include photonic signals having frequencies between direct current (0.0 Hz) and X-rays (approximately 5.3×1020 Hz).

The above embodiments and other aspects and principles of the present invention may be implemented in various environments. Such environments and related applications may be specially constructed for performing the various processes and operations of the invention, or they may include a general-purpose computer or computing platform selectively activated or reconfigured by program code (also referred to as code) to provide the necessary functionality. The processes disclosed herein are not inherently related to any particular computer or other apparatus, and may be implemented by a suitable combination of hardware, software, and/or firmware.

For example, various general-purpose machines may be used with programs written in accordance with the teachings of the present invention, or it may be more convenient to construct a specialized apparatus or system to perform the required methods and techniques. In addition, a general-purpose machine or specialized apparatus may be constructed in accordance with the teachings of the present invention, and such a machine may then be used to practice the invention.

The present invention also relates to computer readable media that include program instructions or program code for performing various computer-implemented operations based on the methods and processes of the invention. The media and program instructions may be those specially designed and constructed for the purposes of the invention, or they may be of the kind well-known and available to those having skill in the computer software arts. Examples of program instructions include microcode, machine code, such as produced by a compiler, and files containing a high-level code that can be executed by the computer using an interpreter, as well as configured optical media consistent with the teachings of the invention.

Although embodiments of the present invention have been described in detail, other embodiments of the invention will be apparent to those skilled in the art from consideration of the specification and practice of the invention disclosed herein. It is intended that the present specification and examples be considered as exemplary only, with a true scope and spirit of the invention being indicated by the following claims.

What is claimed is:

1. An optical matrix, configured as a photonic logic device, comprising:
at least one input port, configured to receive at least one photonic signal;
at least one output port, configured to transmit a logical result signal; and
a plurality of optical elements, that interact with said at least one photonic signal, based on information encoded within said at least one photonic signal, to produce the logical result signal.

2. The optical matrix of claim 1, wherein said optical elements comprise a three-dimensional structure having multiple layers of optical material.

3. The optical matrix of claim 1, wherein said optical elements have at least one dimension smaller than a wavelength of said at least one photonic signal.

4. The optical matrix of claim 1, wherein said optical elements are configured to implement a Boolean function, wherein the logical result signal is an output of the Boolean function based on information encoded within two or more photonic signals received by the optical matrix.

5. The optical matrix of claim 4, wherein said encoded information corresponds to a phase difference between said two or more photonic signals received, that determines an interference pattern of said optical matrix, wherein amplitude of the logical result signal is proportional to an amplitude of said interference pattern.

6. A photonic logic device, comprising:
input means, for receiving at least two photonic signals, having information encoded within said at least two photonic signals received;
output means, for outputting at least one photonic result signal; and
interference means for determining an interference pattern corresponding to a Boolean function of said information encoded within the at least two signals received, wherein an amplitude of said at least one photonic result signal is proportional to an amplitude of said interference pattern.

7. The photonic logic device of claim 6, wherein the amplitude of said at least one photonic result signal corresponds to a Boolean XOR function of said information encoded within said at least two photonic signals received.

8. The photonic logic device of claim 6, wherein the amplitude of said at least one photonic result signal corresponds to a Boolean OR function of said information encoded within said at least two photonic signals received.

9. The photonic logic device of claim 6, wherein said interference means further comprises means for determining an interference pattern, corresponding to any Boolean function of said information encoded within said at least two photonic signals received, by combining Boolean XOR and OR logic functions.

10. The photonic logic device of claim 6, wherein said output means further comprises means for outputting at least two photonic result signals, further comprising:
one or more result signals, each result signal having amplitude proportional to an amplitude of said interference pattern; and
a termination signal, having amplitude proportional to a difference between amplitudes of said at least two photonic signals received and amplitudes of said one or more result signals.

11. A process of routing photonic signals using an optical matrix configured as a photonic switch, comprising:
receiving at least one photonic signal at an input port;
receiving a photonic reference signal at an input port;
processing information, encoded within the at least one photonic signal and the photonic reference signal, using a plurality of optical elements of the optical matrix;
selecting an output port of the optical matrix, according to the processed information; and
transmitting the at least one photonic signal from the selected output port.

12. The process of claim 11, wherein the optical elements comprise a three-dimensional structure, having multiple layers of optical material.

13. The process of claim 11, wherein the optical elements have at least one dimension smaller than a wavelength of the at least one photonic signal.

14. The process of claim 11, wherein:
said optical elements are configured to implement a Boolean function based on information encoded within the at least one photonic signal and the photonic reference signal; and
said output port is selected according to an output of the Boolean function.

15. The process of claim 14, wherein said processing information using a plurality of optical elements further comprises producing an interference pattern based on a phase difference between the at least one photonic signal and the reference photonic signal; and
an amplitude of the at least one photonic signal at the selected output port is proportional to an amplitude of said interference pattern.

16. A system for routing photonic signals using an optical matrix configured as a photonic switch, comprising:
means for receiving at least one photonic signal at an input port;
means for receiving a photonic reference signal at an input port;
means for processing information, encoded within the at least one photonic signal and the photonic reference signal, using a plurality of optical elements of the optical matrix;
means for selecting an output port of the optical matrix, according to the processed information; and
means for transmitting the at least one photonic signal from the selected output port.

17. A method for determining a response of a physical system to photonic signals through a path-tracing system, comprising:
dividing said physical system into unit segments, with each unit segment having a number of faces;
determining probabilities that a photon will intersect with each face of said number of faces for each of said unit segments, where the photon enters a first face of said number of faces;
determining a transition matrix for a path of the photon through said unit segments, based on the determined probabilities;
determining a Markov process to represent said physical system; and
solving the Markov process using said transition matrix to determine the response of the physical system to photonic signals.

18. The method of claim 17, wherein said determining probabilities that the photon will intersect with each face comprises determining said probabilities partially as a function of a geometry of each unit segment.

19. The method of claim 17, wherein said determining probabilities that the photon will intersect with each face comprises assigning a non-zero value to a probability that said photon will intersect again with said first face, when the physical system has phosphorescent or fluorescent properties.

20. The method of claim 17, wherein said determining probabilities that the photon will intersect with each face comprises determining probabilities associated with interactions of photons with electrons to produce optical interference and scattering effects.

21. The method of claim 17, wherein said unit segments have fractal properties.

22. A computer program product comprising:
a computer usable medium having a computer readable program code embodied in said medium for causing a computer to determine a response of a physical system to photonic signals through a path-tracing system, said computer readable program code comprising:
code for dividing said physical system into unit segments, with each unit segment having a number of faces;
code for determining probabilities that a photon will intersect with each face of said number of faces of a first unit segment of said unit segments, where the photon enters a first face of said number of faces;
code for determining a transition matrix for said first unit segment based on the determined probabilities;
code for determining a Markov process to represent said physical system; and
code for solving the Markov process using said transition matrix to determine the response of the physical system to photonic signals.

23. The computer program product of claim 22, wherein said code for determining probabilities comprises code for determining probabilities partially as a function of geometry of each unit segment.

24. The computer program product of claim 22, wherein said code for determining probabilities comprises code for assigning a non-zero value to a probability that said photon will intersect again with said first face, when the physical system has phosphorescent or fluorescent properties.

25. The computer program product of claim 22, wherein said code for determining probabilities comprises code for determining probabilities associated with interactions of photons with electrons to produce optical interference and scattering effects.

26. The computer program product of claim 22, wherein said unit segments have fractal properties.

27. A process for automated design of a device using an evolutionary technique, said process comprising:
representing said device with a configuration of elements of said device;
identifying at least one desired property of said device;
generating at least one fitness metric based on said at least one identified property;
setting a first population of configurations;
determining the fitness of each configuration in said first population of configurations with the at least one fitness metric;
ranking said first population of configurations according to determined fitness of each configuration;
determining if a termination criterion of the evolutionary process is satisfied;
outputting a best ranked configuration in said first population of configurations when said termination criterion is satisfied; and
setting a second population of configurations of elements of said device, using operators selected according to an evolution strategy and said ranked configurations, when said termination criterion is not satisfied.

28. The process of claim 27, wherein said operators include a copy operator for copying at least one configuration from said first population to said second population.

29. The process of claim 27, wherein said operators include a mutate operator for inverting one or more elements in a configuration from said first population and inserting a new configuration having one or more inverted elements into said second population.

30. The process of claim 27, wherein said operators include a meiosis operator for combining elements from at least two configurations from said first population and inserting a new configuration having one or more combined elements into said second population.

31. The process of claim 27, wherein said operators include a random operator for inserting a new configuration having a random elements into said second population.

32. The process of claim 27, wherein said operators include an inversion operator for inverting all elements of a configuration from said first population and inserting a new configuration having inverted elements into said second population.

33. The process of claim 27, wherein each configuration is a software object comprising:
first information, indicating a specific configuration of each element of said device;
second information, indicating whether the fitness of the specific configuration has been determined with the at least one fitness metric; and
third information, indicating a result of determining the fitness of the specific configuration with the at least one fitness metric.

34. The process of claim 27, further comprising a process for configuring an optical matrix as a photonic logic device, said process comprising:
inputting parameters of a physical process performed by said optical matrix to implement the photonic logic device;
said representing comprises representing said physical process with a configuration of optical elements of said optical matrix;
said identifying comprises identifying a logic function to be implemented;
said generating comprises generating at least one fitness metric based on the identified logic function;
said evolutionary process comprises performing a genetic search process, using the at least one fitness metric, to determine an optimal configuration of said optical elements to implement the identified logic function;
said outputting comprises outputting said optimal configuration of said optical elements to implement the identified logic function.

35. The process of claim 34, further comprising mapping said optimal configuration onto said optical matrix using masking techniques.

36. The process of claim 34, wherein performing a genetic search process comprises:
setting an initial population of configurations of optical elements of said optical matrix;
determining the fitness of each configuration in said population of configurations with the at least one fitness metric;
ranking said population of configurations according to determined fitness of each configuration;
determining if a termination criterion of the genetic search process is satisfied;
outputting a best ranked configuration in said population of configurations when said termination criterion is satisfied; and
setting a second population of configurations of optical elements of said optical matrix, using an evolution strategy and the ranked configurations, when said termination criterion is not satisfied.

37. The process of claim 36, wherein said determining the fitness of each configuration comprises determining an interference pattern, produced by said optical elements in response to the photonic signals, by raytracing photons through the optical matrix.

38. The process of claim 37, wherein said raytracing comprises determining probabilistic paths of the photons through the optical matrix.

39. The process of claim 38, wherein said probabilistic paths comprise transfer paths through four-dimensional space, wherein each transfer path has an associated probability that is proportional to a likelihood that the photons will traverse the transfer path.

40. The process of claim 36, wherein said setting the second population comprises applying operators to the ranked configurations, according to the evolution strategy, to generate the second population of configurations.

41. A computer program product comprising:
a computer usable medium having a computer readable program code embodied in said medium for causing a computer to automatically design of a device using an evolutionary technique, said computer readable program code comprising:
code for representing said device with a configuration of elements of said device;
code for identifying at least one desired property of said device;
code for generating at least one fitness metric based on said at least one identified property;
code for setting a first population of configurations;
code for determining the fitness of each configuration in said first population of configurations with the at least one fitness metric;
code for ranking said first population of configurations according to determined fitness of each configuration;
code for determining if a termination criterion of the evolutionary process is satisfied;
code for outputting a best ranked configuration in said first population of configurations when said termination criterion is satisfied; and
code for setting a second population of configurations of elements of said optical matrix, using operators selected according to an evolution strategy and said ranked configurations, when said termination criterion is not satisfied.

42. A system for configuring an optical matrix as a photonic logic device, comprising:
input means for inputting parameters of a physical process performed by said optical matrix to implement the photonic logic device;
storage means for representing said physical process with a configuration of optical elements of said optical matrix;
identification means for identifying a logic function to be implemented;
fitness means for generating at least one fitness metric based on the identified logic function;
search means for performing a genetic search process, using the at least one fitness metric, to determine an optimal configuration of said optical elements to implement the identified logic function; and
output means for outputting said optimal configuration of said optical elements to implement the identified logic function.

43. The system of claim 42, further comprising masking means for mapping said optimal configuration onto said optical matrix using masking techniques.

44. A computer program product comprising:
a computer usable medium having computer readable program code embodied in said medium for causing a computer to determine a configuration of an optical matrix as a photonic logic device, said computer readable program code comprising:
code for inputting parameters of a physical process performed by said optical matrix to implement the photonic logic device;
code for representing said physical process with a configuration of optical elements of said optical matrix;
code for identifying a logic function to be implemented;
code for generating at least one fitness metric based on the identified logic function;
code for performing a genetic search process, using the at least one fitness metric, to determine an optimal configuration of said optical elements to implement the identified logic function; and
code for outputting said optimal configuration of said optical elements to implement the identified logic function.

45. The computer program product of claim 44, further comprising:
code for mapping said optimal configuration onto said optical matrix using masking techniques.

46. The computer program product of claim 44, wherein code for performing a genetic search process comprises:
code for setting an initial population of configurations of optical elements of said optical matrix;
code for determining the fitness of each configuration in said population of configurations with the at least one fitness metric;
code for ranking said population of configurations according to determined fitness of each configuration;
code for determining if a termination criterion of the genetic search process is satisfied;
code for outputting a best ranked configuration in said population of configurations when said termination criterion is satisfied; and
code for setting a second population of configurations of optical elements of said optical matrix, using an evolution strategy and the ranked configurations, when said termination criterion is not satisfied.

47. The computer program product of claim 46, wherein said code for determining the fitness of each configuration comprises:
code for determining an interference pattern, produced by said optical elements in response to photonic signals, by raytracing photons through the optical matrix.

48. The computer program product of claim 47, wherein said code for raytracing comprises code for determining probabilistic paths of the photons through the optical matrix.

49. The computer program product of claim 48, wherein said probabilistic paths comprise transfer paths through four-dimensional space, where each transfer path has an associated probability that is proportional to the likelihood that the photons will traverse the transfer path.

50. The computer program product of claim 46, wherein code for setting a second population of configurations further comprises code for applying operators to the ranked configurations, according to the evolution strategy, to generate the second population of configurations.
